(19) United States
(12) Patent Application Publication
(10) Pub. No.: US 2025/0308075 A1
(43) Pub. Date: Oct. 2, 2025

(54) SELECTION OF PIVOT VERTICES IN POLYGON MESH COMPRESSION

(71) Applicant: Tencent America LLC, Palo Alto, CA (US)

(72) Inventors: Chao HUANG, Palo Alto, CA (US); Shan LIU, San Jose, CA (US)

(73) Assignee: Tencent America LLC, Palo Alto, CA (US)

(21) Appl. No.: 18/922,328

(22) Filed: Oct. 21, 2024

Related U.S. Application Data
(60) Provisional application No. 63/570,219, filed on Mar. 26, 2024.

(51) Int. Cl. G06T 9/00

(52) U.S. Cl. CPC G06T 9/001

(57) ABSTRACT

Aspects of the disclosure includes methods and apparatuses for coding connectivity information of a polygon mesh. A method for decoding the connectivity information includes selecting an active vertex from a plurality of active vertices in a plurality of vertices as a pivot vertex that is to be processed based on a priority of the active vertex. The priority of the active vertex is based on one of (i) a number of processed faces to which the active vertex is incident, (ii) a sum of an angle of each processed incident corner of the active vertex, (iii) a number of unprocessed faces to which the active vertex is incident, and (iv) a number of unprocessed face fans to which the active vertex is incident. The connectivity information of the polygon mesh is reconstructed using the selected active vertex as the pivot vertex.

### INCORPORATION BY REFERENCE

The present application claims the benefit of priority to U.S. Provisional Application No. 63/570,219 filed on Mar. 26, 2024, which is incorporated by reference herein in its entirety.

### TECHNICAL FIELD

The present disclosure describes aspects generally related to mesh processing.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Image/video compression may help transmit image/video data across different devices, storage and networks with minimal quality degradation. In some examples, video codec technology may compress video based on spatial and temporal redundancy. In an example, a video codec may use techniques referred to as intra prediction that may compress an image based on spatial redundancy. For example, the intra prediction may use reference data from the current picture under reconstruction for sample prediction. In another example, a video codec may use techniques referred to as inter prediction that may compress an image based on temporal redundancy. For example, the inter prediction may predict samples in a current picture from a previously reconstructed picture with motion compensation. The motion compensation may be indicated by a motion vector (MV).

Advances in three-dimensional (3D) capture, modeling, and rendering have promoted 3D content across various platforms and devices. For example, a baby's first step in one continent is captured and grandparents may see (and in some cases interact) and enjoy a full immersive experience with the child in another continent. In order to achieve such realism, models are becoming more sophisticated, and a significant amount of data is linked to the creation and consumption of those models. 3D meshes are widely used to represent such immersive contents.

### SUMMARY

Aspects of the disclosure include methods and apparatuses for mesh processing, such as coding connectivity information of a polygon mesh.

Aspects of the disclosure include a decoding method for decoding connectivity information of a polygon mesh. The decoding method includes receiving coded information of a plurality of vertices in the polygon mesh, selecting an active vertex from a plurality of active vertices in the plurality of vertices as a pivot vertex that is to be processed based on a priority of the active vertex from the plurality of active vertices, and reconstructing the connectivity information of the polygon mesh using the selected active vertex as the pivot vertex. The priority of the active vertex is based on one of (i) a number of processed faces to which the active vertex is incident, (ii) a sum of an angle of each processed incident corner of the active vertex, (iii) a number of unprocessed faces to which the active vertex is incident, and (iv) a number of unprocessed face fans to which the active vertex is incident. The active vertex is incident to at least one processed face and at least one unprocessed face, and each face fan includes one face to which the active vertex is incident or consecutive faces to which the active vertex is incident.

Aspects of the disclosure also provide an apparatus for mesh decoding. The apparatus for mesh decoding including processing circuitry configured to implement any of the described methods including the decoding method of mesh processing performed in a decoder.

In an aspect, a method of mesh encoding such as encoding connectivity information of a polygon mesh includes selecting an active vertex from a plurality of active vertices in a plurality of vertices as a pivot vertex that is to be processed based on a priority of the active vertex from the plurality of active vertices, and encoding the connectivity information of the polygon mesh using the selected active vertex as the pivot vertex. The plurality of vertices is in the polygon mesh. The priority of the active vertex is based on one of (i) a number of processed faces to which the active vertex is incident, (ii) a sum of an angle of each processed incident corner of the active vertex, (iii) a number of unprocessed faces to which the active vertex is incident, and (iv) a number of unprocessed face fans to which the active vertex is incident. The active vertex is incident to at least one processed face and at least one unprocessed face, and each face fan includes one face to which the active vertex is incident or consecutive faces to which the active vertex is incident.

Aspects of the disclosure also provide an apparatus for mesh encoding. The apparatus for mesh encoding including processing circuitry configured to implement any of the described methods of mesh processing performed in an encoder.

In an aspect, a method of processing mesh data includes processing a bitstream of the mesh data according to a format rule. The method of processing the mesh data includes processing connectivity information of a polygon mesh according to the format rule. The bitstream includes a connectivity bitstream of the connectivity information of the polygon mesh. The connectivity information may include syntax elements indicating a plurality of vertices in the polygon mesh. The format rule specifies that an active vertex is selected from a plurality of active vertices in the plurality of vertices as a pivot vertex that is to be processed based on a priority of the active vertex from the plurality of active vertices. The priority of the active vertex is based on one of (i) a number of processed faces to which the active vertex is incident, (ii) a sum of an angle of each processed incident corner of the active vertex, (iii) a number of unprocessed faces to which the active vertex is incident, and (iv) a number of unprocessed face fans to which the active vertex is incident, the active vertex is incident to at least one processed face and at least one unprocessed face, and each face fan includes one face to which the active vertex is incident or consecutive faces to which the active vertex is incident. The format rule specifies that the connectivity information of the polygon mesh is reconstructed using the selected active vertex as the pivot vertex.

Aspects of the disclosure also provide a non-transitory computer-readable medium storing instructions which, when executed by a computer, cause the computer to perform any of the described methods for mesh processing.

Technical solutions of the disclosure include aspects directed to reducing signaling requirements for connectivity information, such as signaling of split information including, for example, split vertex offsets and split positions that are associated with split vertices when splits occur. The signaling of split vertex offsets and split positions can occupy a large portion of a connectivity bitstream. The disclosure describes various methods to reduce a number of splits, and thus reducing the amount of signaling of the split information and improving signaling efficiency. For example, a priority of an active vertex in a plurality of active vertices may be determined based on (i) a number of processed faces to which the active vertex is incident, (ii) a sum of an angle of each processed incident corner of the active vertex, (iii) a number of unprocessed faces to which the active vertex is incident, and/or (iv) a number of unprocessed face fans to which the active vertex is incident. Then a pivot vertex may be selected from the plurality of active vertices based on the priorities of the respective active vertices. When the priority is determined based on the above criteria, the convexity of the visited region may be maintained, and thus the number of splits may be reduced. When the number of splits is reduced, the amount of signaling of the split information is reduced, and thus improving the efficiency of connectivity information signaling.

### BRIEF DESCRIPTION OF THE DRAWINGS

Further features, the nature, and various advantages of the disclosed subject matter will be more apparent from the following detailed description and the accompanying drawings in which:

FIG. 1 is a schematic illustration of an example of a block diagram of a communication system (100).

FIG. 2 is a schematic illustration of an example of a block diagram of a decoder.

FIG. 3 is a schematic illustration of an example of a block diagram of an encoder.

FIG. 4 shows an example of an encoding process for mesh processing based on a related video codec according to an aspect of the disclosure.

FIG. 5 shows an example of a decoding process for mesh processing according to an aspect of the disclosure.

FIG. 6 shows an example of a vertex degree of a vertex (611) and a face degree of a face (612) of a polygon mesh (600) according to an aspect of the disclosure.

FIG. 7 shows an example of a primal mesh and a dual mesh according to an aspect of the disclosure.

FIGS. 8-9 show examples of traversal sequences of a dual-degree algorithm according to an aspect of the disclosure.

FIG. 10 shows an example of a polygon-fan according to an aspect of the disclosure.

FIG. 11 shows an example of topological configurations C0-C8 used to compress a triangle-fan connectivity according to an aspect of the disclosure.

FIG. 12 shows an example of a split vertex according to an aspect of the disclosure.

FIG. 13 shows a flow chart outlining a decoding process according to some aspects of the disclosure.

FIG. 14 shows a flow chart outlining an encoding process according to some aspects of the disclosure.

FIG. 15 is a schematic illustration of a computer system in accordance with an aspect.

### DETAILED DESCRIPTION

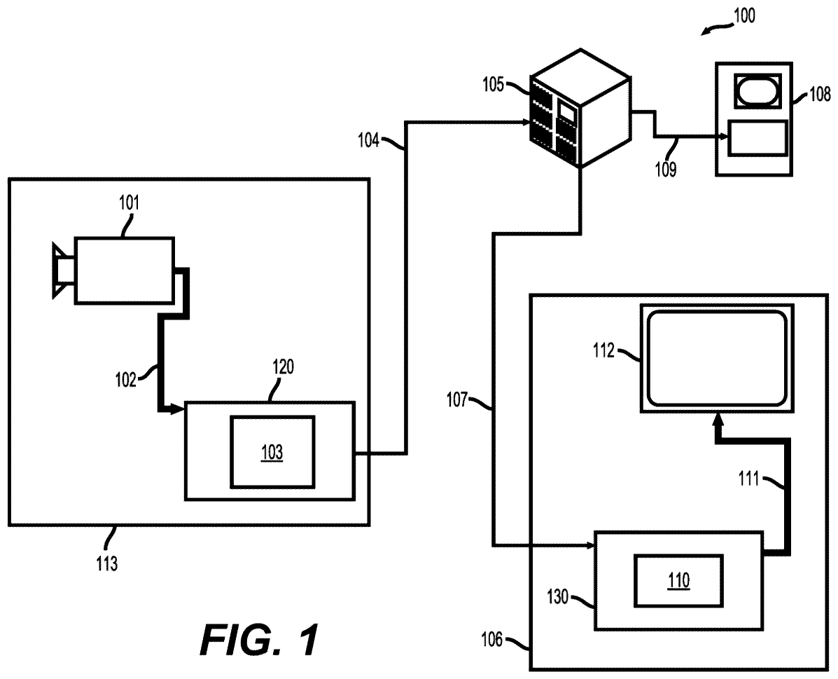

FIG. 1 shows a block diagram of a video processing system (100) in some examples. The video processing system (100) is an example of an application for the disclosed subject matter, a video encoder and a video decoder in a streaming environment. The disclosed subject matter may be equally applicable to other image and/or video enabled applications, including, for example, video conferencing, digital TV, streaming services, storing of compressed video on digital media including CD, DVD, memory stick, and the like.

The video processing system (100) includes a capture subsystem (113), that may include a video source (101). The video source (101) may include one or more images captured by a camera and/or generated by a computer. For example, a digital camera may create a stream of video pictures (102) that are uncompressed. In an example, the stream of video pictures (102) includes samples that are taken by the digital camera. The stream of video pictures (102), depicted as a bold line to emphasize a high data volume when compared to encoded video data (104) (or coded video bitstreams), may be processed by an electronic device (120) that includes a video encoder (103) coupled to the video source (101). The video encoder (103) may include hardware, software, or a combination thereof to enable or implement aspects of the disclosed subject matter as described in more detail below. The encoded video data (104) (or encoded video bitstream), depicted as a thin line to emphasize the lower data volume when compared to the stream of video pictures (102), may be stored on a streaming server (105) for future use. One or more streaming client subsystems, such as client subsystems (106) and (108) in FIG. 1 may access the streaming server (105) to retrieve copies (107) and (109) of the encoded video data (104). A client subsystem (106) may include a video decoder (110), for example, in an electronic device (130). The video decoder (110) decodes the incoming copy (107) of the encoded video data and creates an outgoing stream of video pictures (111) that may be rendered on a display (112) (e.g., display screen) or other rendering device (not depicted). In some streaming systems, the encoded video data (104), (107), and (109) (e.g., video bitstreams) may be encoded according to certain video coding/compression standards. Examples of those standards include ITU-T Recommendation H.265. In an example, a video coding standard under development is informally known as Versatile Video Coding (VVC). The disclosed subject matter may be used in the context of VVC.

It is noted that the electronic devices (120) and (130) may include other components (not shown). For example, the electronic device (120) may include a video decoder (not shown) and the electronic device (130) may include a video encoder (not shown) as well.

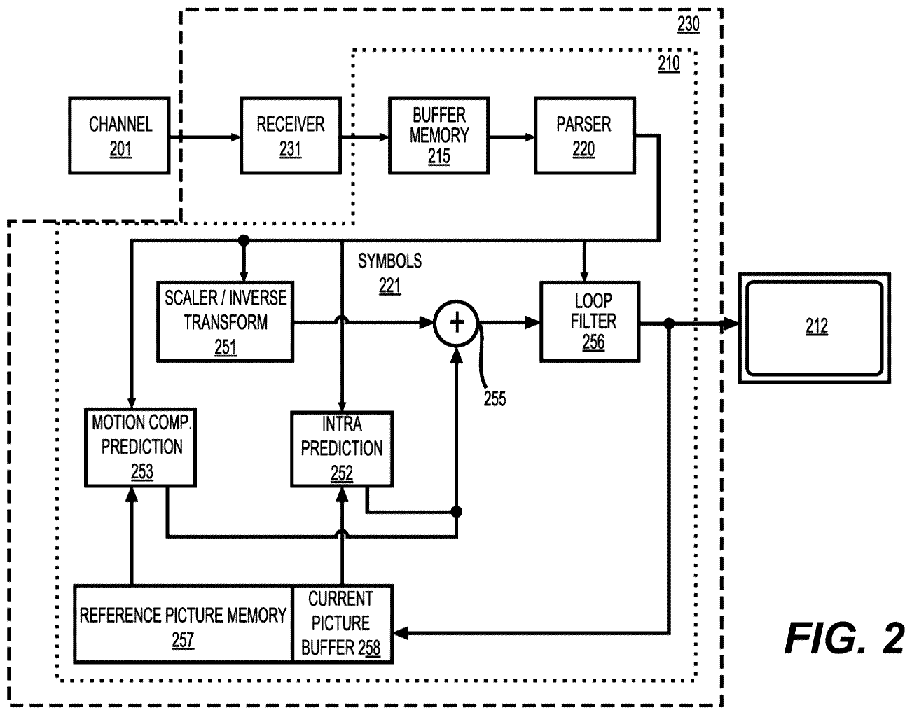

FIG. 2 shows an example of a block diagram of a video decoder (210). The video decoder (210) may be included in an electronic device (230). The electronic device (230) may include a receiver (231). The receiver (231) may include receiving circuitry, such as network interface circuitry. The video decoder (210) may be used in the place of the video decoder (110) in the FIG. 1 example.

The receiver (231) may receive one or more coded video sequences, included in a bitstream for example, to be decoded by the video decoder (210). In an aspect, one coded video sequence is received at a time, where the decoding of each coded video sequence is independent from the decoding of other coded video sequences. The coded video sequence may be received from a channel (201), which may be a hardware/software link to a storage device which stores the encoded video data. The receiver (231) may receive the encoded video data with other data, for example, coded audio data and/or ancillary data streams, that may be forwarded to their respective using entities (not depicted). The receiver (231) may separate the coded video sequence from the other data. To combat network jitter, a buffer memory (215) may be coupled in between the receiver (231) and an entropy decoder/parser (220) (“parser (220)” henceforth). In certain applications, the buffer memory (215) is part of the video decoder (210). In others, it may be outside of the video decoder (210) (not depicted). In still others, there may be a buffer memory (not depicted) outside of the video decoder (210), for example to combat network jitter, and in addition another buffer memory (215) inside the video decoder (210), for example to handle playout timing. When the receiver (231) is receiving data from a store/forward device of sufficient bandwidth and controllability, or from an isosynchronous network, the buffer memory (215) may not be needed, or may be small. For use on best effort packet networks such as the Internet, the buffer memory (215) may be required, may be comparatively large and may be advantageously of adaptive size, and may at least partially be implemented in an operating system or similar elements (not depicted) outside of the video decoder (210).

The video decoder (210) may include the parser (220) to reconstruct symbols (221) from the coded video sequence. Categories of those symbols include information used to manage operation of the video decoder (210), and potentially information to control a rendering device such as a render device (212) (e.g., a display screen) that is not an integral part of the electronic device (230) but may be coupled to the electronic device (230), as shown in FIG. 2. The control information for the rendering device(s) may be in the form of Supplemental Enhancement Information (SEI) messages or Video Usability Information (VUI) parameter set fragments (not depicted). The parser (220) may parse/entropy-decode the coded video sequence that is received. The coding of the coded video sequence may be in accordance with a video coding technology or standard, and may follow various principles, including variable length coding, Huffman coding, arithmetic coding with or without context sensitivity, and so forth. The parser (220) may extract from the coded video sequence, a set of subgroup parameters for at least one of the subgroups of pixels in the video decoder, based upon at least one parameter corresponding to the group. Subgroups may include Groups of Pictures (GOPs), pictures, tiles, slices, macroblocks, Coding Units (CUs), blocks, Transform Units (TUs), Prediction Units (PUs) and so forth. The parser (220) may also extract from the coded video sequence information such as transform coefficients, quantizer parameter values, motion vectors, and so forth.

The parser (220) may perform an entropy decoding/parsing operation on the video sequence received from the buffer memory (215), so as to create symbols (221).

Reconstruction of the symbols (221) may involve multiple different units depending on the type of the coded video picture or parts thereof (such as: inter and intra picture, inter and intra block), and other factors. Which units are involved, and how, may be controlled by subgroup control information parsed from the coded video sequence by the parser (220). The flow of such subgroup control information between the parser (220) and the multiple units below is not depicted for clarity.

Beyond the functional blocks already mentioned, the video decoder (210) may be conceptually subdivided into a number of functional units as described below. In a practical implementation operating under commercial constraints, many of these units interact closely with each other and may, at least partly, be integrated into each other. However, for the purpose of describing the disclosed subject matter, the conceptual subdivision into the functional units below is appropriate.

A first unit is the scaler/inverse transform unit (251). The scaler/inverse transform unit (251) receives a quantized transform coefficient as well as control information, including which transform to use, block size, quantization factor, quantization scaling matrices, etc. as symbol(s) (221) from the parser (220). The scaler/inverse transform unit (251) may output blocks comprising sample values, that may be input into aggregator (255).

In some cases, the output samples of the scaler/inverse transform unit (251) may pertain to an intra coded block. The intra coded block is a block that is not using predictive information from previously reconstructed pictures, but may use predictive information from previously reconstructed parts of the current picture. Such predictive information may be provided by an intra picture prediction unit (252). In some cases, the intra picture prediction unit (252) generates a block of the same size and shape of the block under reconstruction, using surrounding already reconstructed information fetched from the current picture buffer (258). The current picture buffer (258) buffers, for example, partly reconstructed current picture and/or fully reconstructed current picture. The aggregator (255), in some cases, adds, on a per sample basis, the prediction information the intra prediction unit (252) has generated to the output sample information as provided by the scaler/inverse transform unit (251).

In other cases, the output samples of the scaler/inverse transform unit (251) may pertain to an inter coded, and potentially motion compensated, block. In such a case, a motion compensation prediction unit (253) may access reference picture memory (257) to fetch samples used for prediction. After motion compensating the fetched samples in accordance with the symbols (221) pertaining to the block, these samples may be added by the aggregator (255) to the output of the scaler/inverse transform unit (251) (in this case called the residual samples or residual signal) so as to generate output sample information. The addresses within the reference picture memory (257) from where the motion compensation prediction unit (253) fetches prediction samples may be controlled by motion vectors, available to the motion compensation prediction unit (253) in the form of symbols (221) that may have, for example X, Y, and reference picture components. Motion compensation also may include interpolation of sample values as fetched from the reference picture memory (257) when sub-sample exact motion vectors are in use, motion vector prediction mechanisms, and so forth.

The output samples of the aggregator (255) may be subject to various loop filtering techniques in the loop filter unit (256). Video compression technologies may include in-loop filter technologies that are controlled by parameters included in the coded video sequence (also referred to as coded video bitstream) and made available to the loop filter unit (256) as symbols (221) from the parser (220). Video compression may also be responsive to meta-information obtained during the decoding of previous (in decoding order) parts of the coded picture or coded video sequence, as well as responsive to previously reconstructed and loop-filtered sample values.

The output of the loop filter unit (256) may be a sample stream that may be output to the render device (212) as well as stored in the reference picture memory (257) for use in future inter-picture prediction.

Certain coded pictures, once fully reconstructed, may be used as reference pictures for future prediction. For example, once a coded picture corresponding to a current picture is fully reconstructed and the coded picture has been identified as a reference picture (by, for example, the parser (220)), the current picture buffer (258) may become a part of the reference picture memory (257), and a fresh current picture buffer may be reallocated before commencing the reconstruction of the following coded picture.

The video decoder (210) may perform decoding operations according to a predetermined video compression technology or a standard, such as ITU-T Rec. H.265. The coded video sequence may conform to a syntax specified by the video compression technology or standard being used, in the sense that the coded video sequence adheres to both the syntax of the video compression technology or standard and the profiles as documented in the video compression technology or standard. Specifically, a profile may select certain tools as the only tools available for use under that profile from all the tools available in the video compression technology or standard. Also necessary for compliance may be that the complexity of the coded video sequence is within bounds as defined by the level of the video compression technology or standard. In some cases, levels restrict the maximum picture size, maximum frame rate, maximum reconstruction sample rate (measured in, for example megasamples per second), maximum reference picture size, and so on. Limits set by levels may, in some cases, be further restricted through Hypothetical Reference Decoder (HRD) specifications and metadata for HRD buffer management signaled in the coded video sequence.

In an aspect, the receiver (231) may receive additional (redundant) data with the encoded video. The additional data may be included as part of the coded video sequence(s). The additional data may be used by the video decoder (210) to properly decode the data and/or to more accurately reconstruct the original video data. Additional data may be in the form of, for example, temporal, spatial, or signal noise ratio (SNR) enhancement layers, redundant slices, redundant pictures, forward error correction codes, and so on.

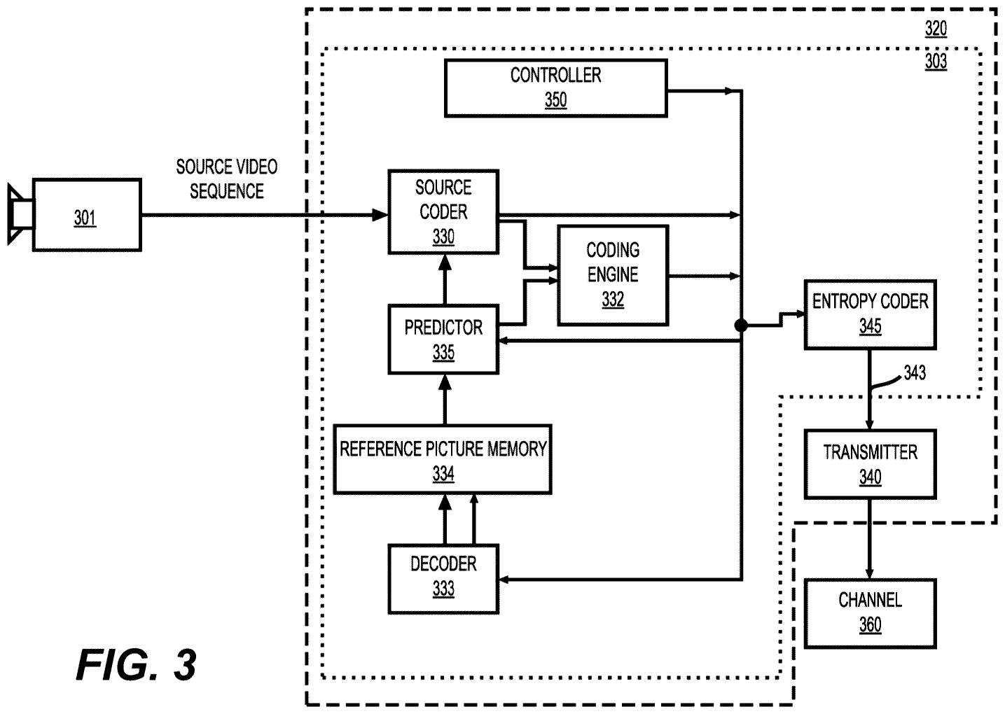

FIG. 3 shows an example of a block diagram of a video encoder (303). The video encoder (303) is included in an electronic device (320). The electronic device (320) includes a transmitter (340) (e.g., transmitting circuitry). The video encoder (303) may be used in the place of the video encoder (103) in the FIG. 1 example.

The video encoder (303) may receive video samples from a video source (301) (that is not part of the electronic device (320) in the FIG. 3 example) that may capture video image(s) to be coded by the video encoder (303). In another example, the video source (301) is a part of the electronic device (320).

The video source (301) may provide the source video sequence to be coded by the video encoder (303) in the form of a digital video sample stream that may be of any suitable bit depth (for example: 8 bit, 10 bit, 12 bit, . . . ), any colorspace (for example, BT.601 Y CrCB, RGB, . . . ), and any suitable sampling structure (for example Y CrCb 4:2:0, Y CrCb 4:4:4). In a media serving system, the video source (301) may be a storage device storing previously prepared video. In a videoconferencing system, the video source (301) may be a camera that captures local image information as a video sequence. Video data may be provided as a plurality of individual pictures that impart motion when viewed in sequence. The pictures themselves may be organized as a spatial array of pixels, wherein each pixel may include one or more samples depending on the sampling structure, color space, etc. in use. The description below focuses on samples.

According to an aspect, the video encoder (303) may code and compress the pictures of the source video sequence into a coded video sequence (343) in real time or under any other time constraints as required. Enforcing appropriate coding speed is one function of a controller (350). In some aspects, the controller (350) controls other functional units as described below and is functionally coupled to the other functional units. The coupling is not depicted for clarity. Parameters set by the controller (350) may include rate control related parameters (picture skip, quantizer, lambda value of rate-distortion optimization techniques, . . . ), picture size, group of pictures (GOP) layout, maximum motion vector search range, and so forth. The controller (350) may be configured to have other suitable functions that pertain to the video encoder (303) optimized for a certain system design.

In some aspects, the video encoder (303) is configured to operate in a coding loop. As an oversimplified description, in an example, the coding loop may include a source coder (330) (e.g., responsible for creating symbols, such as a symbol stream, based on an input picture to be coded, and a reference picture(s)), and a (local) decoder (333) embedded in the video encoder (303). The decoder (333) reconstructs the symbols to create the sample data in a similar manner as a (remote) decoder also would create. The reconstructed sample stream (sample data) is input to the reference picture memory (334). As the decoding of a symbol stream leads to bit-exact results independent of decoder location (local or remote), the content in the reference picture memory (334) is also bit exact between the local encoder and remote encoder. In other words, the prediction part of an encoder “sees” as reference picture samples exactly the same sample values as a decoder would “see” when using prediction during decoding. This fundamental principle of reference picture synchronicity (and resulting drift, if synchronicity may not be maintained, for example because of channel errors) is used in some related arts as well.

The operation of the “local” decoder (333) may be the same as a “remote” decoder, such as the video decoder (210), which has already been described in detail above in conjunction with FIG. 2. Briefly referring also to FIG. 2, however, as symbols are available and encoding/decoding of symbols to a coded video sequence by an entropy coder (345) and the parser (220) may be lossless, the entropy decoding parts of the video decoder (210), including the buffer memory (215), and parser (220) may not be fully implemented in the local decoder (333).

In an aspect, a decoder technology except the parsing/entropy decoding that is present in a decoder is present, in an identical or a substantially identical functional form, in a corresponding encoder. Accordingly, the disclosed subject matter focuses on decoder operation. The description of encoder technologies may be abbreviated as they are the inverse of the comprehensively described decoder technologies. In certain areas a more detail description is provided below.

During operation, in some examples, the source coder (330) may perform motion compensated predictive coding, which codes an input picture predictively with reference to one or more previously coded picture from the video sequence that were designated as “reference pictures.” In this manner, the coding engine (332) codes differences between pixel blocks of an input picture and pixel blocks of reference picture(s) that may be selected as prediction reference(s) to the input picture.

The local video decoder (333) may decode coded video data of pictures that may be designated as reference pictures, based on symbols created by the source coder (330). Operations of the coding engine (332) may advantageously be lossy processes. When the coded video data may be decoded at a video decoder (not shown in FIG. 3), the reconstructed video sequence typically may be a replica of the source video sequence with some errors. The local video decoder (333) replicates decoding processes that may be performed by the video decoder on reference pictures and may cause reconstructed reference pictures to be stored in the reference picture memory (334). In this manner, the video encoder (303) may store copies of reconstructed reference pictures locally that have common content as the reconstructed reference pictures that will be obtained by a far-end video decoder (absent transmission errors).

The predictor (335) may perform prediction searches for the coding engine (332). That is, for a new picture to be coded, the predictor (335) may search the reference picture memory (334) for sample data (as reference pixel blocks) or certain metadata such as reference picture motion vectors, block shapes, and so on, that may serve as an appropriate prediction reference for the new pictures. The predictor (335) may operate on a sample block-by-pixel block basis to find appropriate prediction references. In some cases, as determined by search results obtained by the predictor (335), an input picture may have prediction references drawn from multiple reference pictures stored in the reference picture memory (334).

The controller (350) may manage coding operations of the source coder (330), including, for example, setting of parameters and subgroup parameters used for encoding the video data.

Output of all aforementioned functional units may be subjected to entropy coding in the entropy coder (345). The entropy coder (345) translates the symbols as generated by the various functional units into a coded video sequence, by applying lossless compression to the symbols according to technologies such as Huffman coding, variable length coding, arithmetic coding, and so forth.

The transmitter (340) may buffer the coded video sequence(s) as created by the entropy coder (345) to prepare for transmission via a communication channel (360), which may be a hardware/software link to a storage device which would store the encoded video data. The transmitter (340) may merge coded video data from the video encoder (303) with other data to be transmitted, for example, coded audio data and/or ancillary data streams (sources not shown).

The controller (350) may manage operation of the video encoder (303). During coding, the controller (350) may assign to each coded picture a certain coded picture type, which may affect the coding techniques that may be applied to the respective picture. For example, pictures often may be assigned as one of the following picture types:

An Intra Picture (I picture) may be coded and decoded without using any other picture in the sequence as a source of prediction. Some video codecs allow for different types of intra pictures, including, for example Independent Decoder Refresh (“IDR”) Pictures.

A predictive picture (P picture) may be coded and decoded using intra prediction or inter prediction using at most one motion vector and reference index to predict the sample values of each block.

A bi-directionally predictive picture (B Picture) may be coded and decoded using intra prediction or inter prediction using two motion vectors and reference indices to predict the sample values of each block. Similarly, multiple-predictive pictures may use more than two reference pictures and associated metadata for the reconstruction of a single block.

Aspect of the present disclosure may also be applied to variants of I pictures, P pictures, and B pictures, and their respective applications and features.

Source pictures commonly may be subdivided spatially into a plurality of sample blocks (for example, blocks of 4×4, 8×8, 4×8, or 16×16 samples each) and coded on a block-by-block basis. Blocks may be coded predictively with reference to other (already coded) blocks as determined by the coding assignment applied to the blocks' respective pictures. For example, blocks of I pictures may be coded non-predictively or they may be coded predictively with reference to already coded blocks of the same picture (spatial prediction or intra prediction). Pixel blocks of P pictures may be coded predictively, via spatial prediction or via temporal prediction with reference to one previously coded reference picture. Blocks of B pictures may be coded predictively, via spatial prediction or via temporal prediction with reference to one or two previously coded reference pictures.

The video encoder (303) may perform coding operations according to a predetermined video coding technology or standard, such as ITU-T Rec. H.265. In its operation, the video encoder (303) may perform various compression operations, including predictive coding operations that exploit temporal and spatial redundancies in the input video sequence. The coded video data, therefore, may conform to a syntax specified by the video coding technology or standard being used.

In an aspect, the transmitter (340) may transmit additional data with the encoded video. The source coder (330) may include such data as part of the coded video sequence. Additional data may include temporal/spatial/SNR enhancement layers, other forms of redundant data such as redundant pictures and slices, SEI messages, VUI parameter set fragments, and so on.

A video may be captured as a plurality of source pictures (video pictures) in a temporal sequence. Intra-picture prediction (often abbreviated to intra prediction) makes use of spatial correlation in a given picture, and inter-picture prediction makes use of the (temporal or other) correlation between the pictures. In an example, a specific picture under encoding/decoding, which is referred to as a current picture, is partitioned into blocks. When a block in the current picture is similar to a reference block in a previously coded and still buffered reference picture in the video, the block in the current picture may be coded by a vector that is referred to as a motion vector. The motion vector points to the reference block in the reference picture, and may have a third dimension identifying the reference picture, in case multiple reference pictures are in use.

In some aspects, a bi-prediction technique may be used in the inter-picture prediction. According to the bi-prediction technique, two reference pictures, such as a first reference picture and a second reference picture that are both prior in decoding order to the current picture in the video (but may be in the past and future, respectively, in display order) are used. A block in the current picture may be coded by a first motion vector that points to a first reference block in the first reference picture, and a second motion vector that points to a second reference block in the second reference picture. The block may be predicted by a combination of the first reference block and the second reference block.

Further, a merge mode technique may be used in the inter-picture prediction to improve coding efficiency.

According to some aspects of the disclosure, predictions, such as inter-picture predictions and intra-picture predictions, are performed in the unit of blocks, such as a polygon-shaped or triangular block. For example, according to the HEVC standard, a picture in a sequence of video pictures is partitioned into coding tree units (CTU) for compression, the CTUs in a picture have the same size, such as 64×64 pixels, 32×32 pixels, or 16×16 pixels. In general, a CTU includes three coding tree blocks (CTBs), which are one luma CTB and two chroma CTBs. Each CTU may be recursively quadtree split into one or multiple coding units (CUs). For example, a CTU of 64×64 pixels may be split into one CU of 64×64 pixels, 4 CUs of 32×32 pixels, or 16 CUs of 16×16 pixels. In an example, each CU is analyzed to determine a prediction type for the CU, such as an inter prediction type or an intra prediction type. The CU is split into one or more prediction units (PUs) depending on the temporal and/or spatial predictability. Generally, each PU includes a luma prediction block (PB), and two chroma PBs. In an aspect, a prediction operation in coding (encoding/decoding) is performed in the unit of a prediction block. Using a luma prediction block as an example of a prediction block, the prediction block includes a matrix of values (e.g., luma values) for pixels, such as 8×8 pixels, 16×16 pixels, 8×16 pixels, 16×8 pixels, and the like.

It is noted that the video encoders (103) and (303), and the video decoders (110) and (210) may be implemented using any suitable technique. In an aspect, the video encoders (103) and (303) and the video decoders (110) and (210) may be implemented using one or more integrated circuits. In another aspect, the video encoders (103) and (303), and the video decoders (110) and (210) may be implemented using one or more processors that execute software instructions.

The disclosure includes aspects related to methods and apparatuses to select pivot vertices for polygon mesh compression.

A mesh may include a plurality of polygons (such as a plurality of polygonal faces) that may describe a surface of a volumetric object. For example, the surface of the volumetric object may be approximated using the mesh. Each polygon of the mesh may be defined by vertices of the corresponding polygon in a three-dimensional (3D) space and information of how the vertices are connected, which may be referred to as connectivity information. In some aspects, vertex attributes, such as colors, normals, displacements, and the like, may be associated with the vertices (also referred to as the mesh vertices). Attributes (also referred to as vertex attributes) may also be associated with the surface of the mesh by exploiting mapping information that parameterizes the mesh with two-dimensional (2D) attribute maps. Such mapping may be described by a set of parametric coordinates, referred to as UV coordinates or texture coordinates, associated with the mesh vertices. 2D attribute maps may be used to store high resolution attribute information such as texture, normals, displacements, and the like. The high resolution attribute information may be used for various purposes such as texture mapping, shading, and mesh reconstruction.

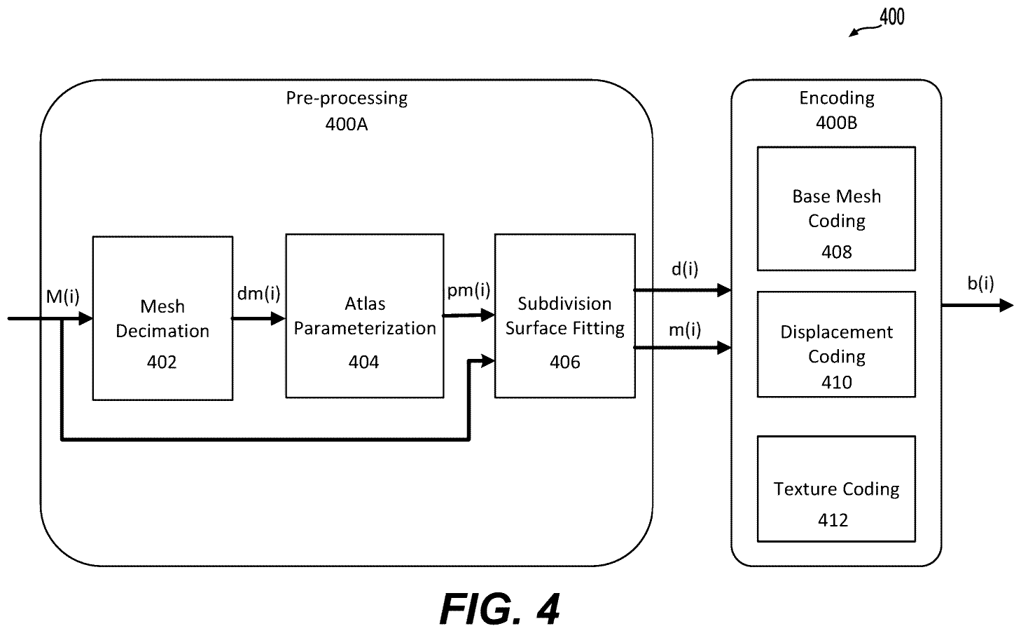

FIG. 4 shows an example of an encoding process (400) for mesh processing based on a related video codec according to an aspect of the disclosure. As shown in FIG. 4, the encoding process (400) may include a pre-processing step (400A) and an encoding step (400B). The pre-processing step (400A) may be configured to generate a base mesh m(i) of a current frame and a displacement field d(i) of the current frame that includes displacement vectors according to an input mesh M(i) of the current frame. The encoding step (400B) may be configured to encode the base mesh m(i), the displacement field d(i), and texture information of the base mesh m(i). The displacement field d(i) of the current frame may include displacement vectors. An index i may refer to the current frame. In an aspect, a mode decision method may be performed in the encoding process (400) to determine whether inter coding (also referred to as inter frame prediction or an inter mode), intra coding (also referred to as intra frame prediction or an intra mode), or the like is applied to the current frame. For example, the mode decision method may compare a cost of an intra mode and a cost of an inter mode and decide a coding mode of the base mesh m(i) of the current frame based on which one of the costs is smaller. In some examples, a skip mode is used to code (e.g., encode or decode) the base mesh m(i). In an example, the skip mode is a special mode of the inter mode. For example, the base mesh m(i) may be intra coded, or inter coded, or coded with the SKIP mode.

Still referring to FIG. 4, the pre-processing step (400A) may include a mesh decimation process (402), a parameterization process such as an atlas parameterization process (404), and a subdivision surface fitting process (406). The mesh decimation process (402) is configured to down-sample vertices of the input mesh M(i) to generate a decimated mesh dm(i) that may include a plurality of decimated (or down-sampled) vertices. A number of the plurality of decimated vertices is less than a number of the vertices of the input mesh M(i). The parameterization process such as the atlas parameterization process (404) is configured to map the decimated mesh dm(i) onto a planar domain, such as onto a UV atlas (or a UV map), to generate a re-parameterized mesh pm(i). In an example, the atlas parameterization may be performed based on a video processing tool, such as a UVAtlas tool. The subdivision surface fitting process (406) is configured to take the re-parameterized mesh pm(i) and the input mesh M(i) as inputs and produce a based mesh m(i) together with the displacement field d(i) that includes the displacement vectors or a set of displacements. In an example of the subdivision surface fitting process (406), pm(i) is subdivided by using a subdivision scheme such as an iterative interpolation to obtain a subdivided mesh. The iterative interpolation includes inserting at each iteration a new point in a middle of each edge of the re-parameterized mesh pm(i). Any suitable subdivision scheme may be applied to subdivide pm(i). The displacement field d(i) is computed by determining a nearest point on a surface of the input mesh M(i) for each vertex of the subdivided mesh.

An advantage of the subdivided mesh may include that the subdivided mesh has a subdivision structure that allows efficient compression, while offering a faithful approximation of the input mesh. The compression efficiency may be obtained due to the following properties. The decimated mesh dm(i) may have a low number of vertices and may be encoded and transmitted using a lower number of bits than the input mesh M(i) or the subdivided mesh. Referring to FIG. 4, the base mesh m(i) may be generated from the decimated mesh dm(i). In an example, the base mesh m(i) is the decimated mesh dm(i). As the subdivided mesh may be generated based on the subdivision method, the subdivided mesh may be automatically generated by the decoder when the base mesh or the decimated mesh is decoded (e.g., there is no need to use any information other than the subdivision scheme and a subdivision iteration count). At the decoder side, the displacement field d(i) may be generated by decoding the displacement vectors associated with the vertices of the subdivided mesh. Besides allowing for spatial/quality scalability, the subdivision structure enables efficient transforms such as wavelet decomposition, which can offer high compression performance.

The encoding step (400B) may include a base mesh coding (408), a displacement coding (410), a texture coding (412), and the like. The base mesh coding (408) is configured to encode geometric information of the base mesh m(i) associated with the current frame. In an intra encoding, the base mesh m(i) may be first quantized (e.g., using uniform quantization) and then encoded, for example, by the coding mode determined using the mode decision method. The coding mode may be the inter mode, the intra mode, the skip mode, or the like. The encoder used to intra code the base mesh m(i) may be referred to as a static mesh encoder. In the inter encoding, a reference base mesh (e.g., a reconstructed quantized reference base mesh m′(j)) associated with a reference frame indicated by an index j may be used to predict the base mesh m(i) associated with the current frame indicated by the index i. The displacement coding (410) is configured to encode the displacement field d(i) that is generated in the pre-processing step (400A). The displacement field d(i) may include a set of displacement vectors (or displacements) associated with the subdivided mesh vertices. The texture coding (412) is configured to encode attribute information of the base mesh m(i). The attribute information may include texture, normal, color, and/or the like. The attribute information may be encoded based on a suitable codec, such as High-Efficiency Video Coding (HEVC) or Versatile Video Coding (VVC).

In an aspect, referring to FIG. 4, a mesh encoding process such as the encoding process (400) starts with a pre-processing (e.g., the pre-processing step (400A)). The pre-processing may convert the input mesh M(i) into the base mesh m(i) together with the displacement field d(i) including a set of displacements (or a set of displacement vectors). The encoding step (400B) may compress outputs (e.g., m(i), d(i), and the like) from the pre-processing and generate a compressed bitstream b(i). The compressed bitstream b(i) may include a compressed base mesh bitstream, a compressed displacement field bitstream (also referred to as a compressed displacement bitstream), a compressed attribute bitstream, and/or the like.

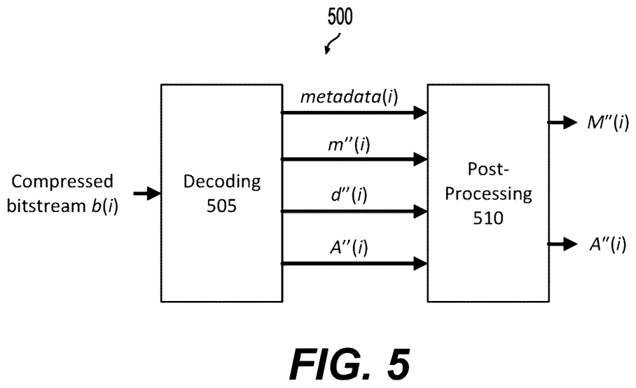

FIG. 5 shows an example of a decoding process (500) for mesh processing according to an aspect of the disclosure. The decoding process (500) may include a decoding step (505) and a post-processing step (510). A compressed bitstream b(i) may be fed to the decoding step (505). In an example, for a lossless transmission, the compressed bitstream b(i) is the output b(i) from the encoding process (400). The decoding step (505) may extract various sub-bitstreams such as the compressed base mesh sub-stream, the compressed displacement field sub-stream, the compressed attribute sub-stream, and/or the like. The decoding step (505) may decompress the sub-bitstreams to generate the following components: patch metadata indicated by metadata (i), a decoded base mesh m″(i), a decoded displacement field (including displacements) d″(i), a decoded attribute map A″(i), and/or the like.

In an aspect, the base mesh sub-stream may be fed to a mesh decoder to generate a reconstructed quantized base mesh m′(i). The decoded base mesh m″(i) may be obtained by applying an inverse quantization to m′(i). The displacement field sub-stream including packed and quantized wavelet coefficients that are encoded may be decoded by a video and/or image decoder. Image unpacking and inverse quantization may be applied to the packed quantized wavelet coefficients that are reconstructed to obtain the unpacked and dequantized transformed coefficients (e.g., wavelet coefficients). An inverse wavelet transform may be applied to the unpacked and dequantized wavelet coefficients to generate the decoded displacement field d″(i).

The decoded components (e.g., including metadata (i), m″(i), d″(i), A″(i), and/or the like) may be fed to a post-processing step (510). A mesh (also referred to as a decoded mesh) M″(i) may be generated by the post-processing step (510) based on m″(i) and d″(i). In an example, the reconstructed deformed mesh DM(i) may be obtained by subdividing m″(i) using a subdivision scheme and applying the reconstructed displacements d″(i) to vertices of a subdivided mesh. In an example, when the encoding process (400), the decoding process (500), and the transmission are lossless, the mesh M″(i) may be identical to the input mesh M(i). When one of the encoding process (400), the decoding process (500), and the transmission is lossy, M″(i) is different from M(i). In various examples, the difference, if any, between M″(i) and M(i) is relatively small. In an example, an attribute map A″(i) is also generated by the post-processing step (510).

A polygon mesh (also interchangeably referred to as a polygonal mesh) may include topologic quantities, such as vertices, edges, and faces, and geometric quantities, such as attributes including vertex positions, face colors, and the like. Connectivity information of a polygon mesh may describe incidences between elements and may be implied by the topology. For example, two vertices are adjacent when an edge is incident to the two vertices. For example, two faces are adjacent when an edge is incident to the two faces.

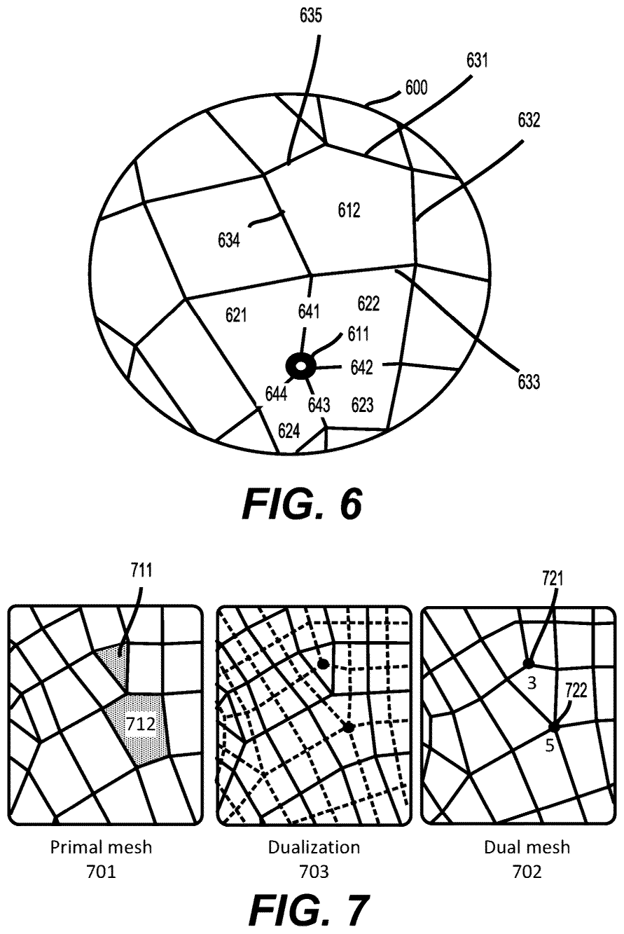

FIG. 6 shows an example of a vertex degree of a vertex (611) and a face degree of a face (612) of a polygon mesh (600) according to an aspect of the disclosure. The polygon mesh (600) may include a plurality of faces that includes the face (612). The polygon mesh (600) may include a plurality of vertices that includes the vertex (611). In an aspect, a vertex degree of a vertex may be interchangeably referred to as a valence of the vertex. A vertex degree of a vertex may specify a number of edges incident to the vertex. Referring to FIG. 6, the vertex degree of the vertex (611) may specify a number of edges (641)-(644) incident to the vertex (611), and the vertex degree of the vertex (611) is 4. A face degree of a face may specify a number of incident edges of the face. Referring to FIG. 6, the face degree of the face (612) may specify a number of incident edges (631)-(635) of the face (612), and the face degree of the face (612) is 5. A ring of a vertex may refer to a list such as an ordered list of all incident faces to the vertex. Referring to FIG. 6, a ring of the vertex (611) may refer to an ordered list of all incident faces (621)-(624) to the vertex (611).

Various methods may be used to encode connectivity of a polygon mesh. In some examples, a dual-degree based method (also referred to as a dual-degree based polygon mesh compression method or a dual-degree method) and a polygon-fan based method (also referred to as a polygon-fan based polygon mesh compression method or a polygon-fan method) may be used to encode connectivity of a polygon mesh, for example, by traversing the polygon mesh and encoding the connectivity around each pivot vertex during the traversal.

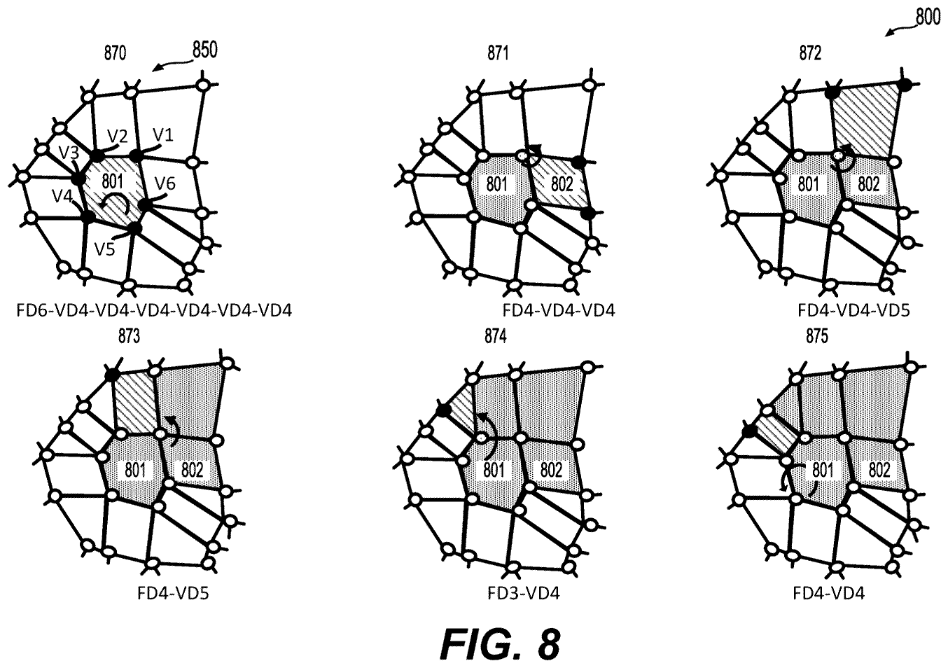

In an aspect, the dual-degree based method may efficiently encode connectivity of a polygon mesh with arbitrary face degrees or arbitrary vertex degrees. The dual-degree based method may use the duality between a primal mesh and a dual mesh to encode the connectivity by generating two sequences of symbols, the vertex degrees and face degrees. FIG. 7 shows an example of a primal mesh (701) and a dual mesh (702) according to an aspect of the disclosure. The dual mesh (702) may be built by a dualization process (703), for example, by placing one node in each original face in the primal mesh (701) and connecting the nodes through each edge incident to two original faces in the primal mesh (701). In an aspect, an original face in the primal mesh (701) having a face degree of N1 corresponds to a vertex in the dual mesh (702) having a vertex degree of N1 where the vertex is the node inside the original face. Referring to FIG. 7, an original face (711) in the primal mesh (701) having a face degree of 3 corresponds to a vertex (721) in the dual mesh (702) having a vertex degree of 3. Referring to FIG. 7, an original face (712) in the primal mesh (701) having a face degree of 5 corresponds to a vertex (722) in the dual mesh (702) having a vertex degree of 5.

The dual-degree based method may encode the two sequences of symbols separately. In an example, the dual-degree based method uses a sequence of vertex degrees and a sequence of face degrees. In some examples, coding performance of the dual-degree based method depends highly on a mesh regularity. A mesh regularity may indicate (e.g., measure) a variance of the vertex degrees of the polygon mesh and/or a variance of face degrees of the polygon mesh. In an aspect, the less of the variance of the vertex degrees, the more regular the polygon mesh, and the higher the connectivity coding efficiency. In an aspect, the less of the variance of the face degrees, the more regular the polygon mesh, and the higher the connectivity coding efficiency. In some related technologies, the dual-degree based method is near-optimal for worst-case meshes, where the entropy of the two sequences of symbols may achieve Tutte entropy bound for planar graphs of 2 bits per edge.

In an aspect, vertex and face data structures may be maintained explicitly. For a vertex, a vertex degree (VD) and references to all incident faces in an order (e.g., a counterclockwise order) may be stored in a data structure associated with the vertex. For a face, a face degree (FD) and references to all incident vertices in an order (e.g., a counterclockwise order) may be stored. Vertices and faces may go through a sequence of states such as an empty state, an active state, and a complete state. In an example, at a given time at most one face is active, and multiple vertices may be active. In an example, the multiple active vertices may be held in an active vertex queue. When a face is processed, for example, moved from an empty state (e.g., when the face is not processed), to an active state (e.g., when the face is being processed), and then to a complete state (e.g., when the face is processed), all vertices of the face that are not yet active may be activated through insertion into the active vertex queue. Consequently, each active vertex has at least one complete incident face. When none of faces incident to a vertex is processed, the vertex is not an active vertex and is in an empty state. The vertex is not visited. When all the faces incident to a vertex have become complete (e.g., all the faces are processed), the vertex changes its state to complete (e.g., the vertex is processed) and may be removed from the active vertex queue.

In some examples, the active vertex queue is an active vertex priority queue where an active index having the highest priority is traversed prior to other active indices in the active vertex queue. For example, the active index having the highest priority is made the current vertex such as the pivot vertex, and is processed and then removed from the active vertex queue. In an example, the active vertex queue represents a boundary between a part of the polygon mesh which has already been traversed and a part of the polygon mesh as yet to be visited.

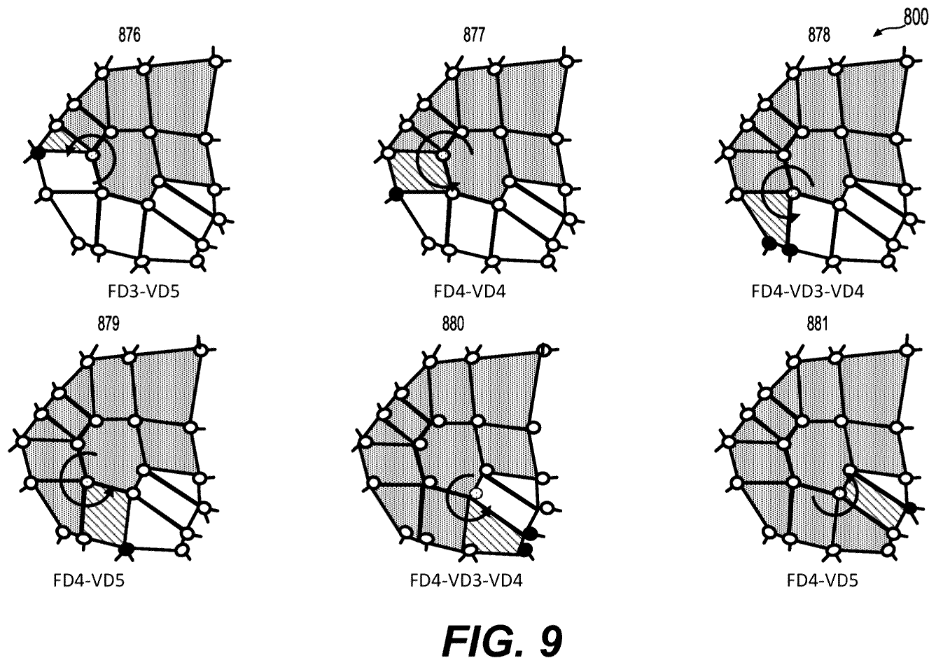

FIGS. 8-9 show an example of a traversal sequence (800) of the dual-degree algorithm according to an aspect of the disclosure. In an example, the traversal sequence (800) may start from a seed face (801) of a polygon mesh (850). At the beginning (e.g., at a step (870)), a seed face degree (FD) (e.g., 6 as indicated by FD6) may be output along with vertex degrees of all vertices of the seed face (801). In the example shown in FIG. 8, the seed face (801) has 6 vertices V1-V6, each of the vertices has a vertex degree (VD) of 4 as indicated by VD4.

At a step (871), a first vertex (e.g., V1) of the seed face (801) may become active and a next face (802) may be traversed, for example, in a counterclockwise order, resulting in one face degree and two vertex valences output, such as FD4, VD4, and VD4.

The traversal keeps going until all the faces and vertices in the polygon mesh (850) have been visited.

In an example, the seed face (801) is chosen and all neighbors of the seed face (801) are traversed recursively until all faces of the corresponding connected component are visited. Referring to FIGS. 8-9, a subset of all neighbors of the seed face (801) is traversed in the steps (872)-(881). A new seed face of the next connected component is then chosen and the traversal sequence (800) may continue. Every time the encoder traverses the next element of the polygon mesh (850), the encoder may output some symbol which uniquely identifies a new state. From this stream of symbols, the decoder can reconstruct the polygon mesh (850). In an example, two sets of symbols may be used to encode vertex degrees and face degrees. At a given moment, the encoder and the decoder may know which type of symbol (face or vertex) is being dealt with.

In an aspect, the mesh traversal such as the traversal sequence (800) may be started by selecting the seed face (801). The encoder outputs the face degree of the seed face (801), followed by the vertex degrees of all the vertices V1-V6 incident to the seed face (801), e.g., in a counterclockwise order such as FD6-VD4-VD4-VD4-VD4-VD4-VD4 in the step (870). The vertices (e.g., the 6 vertices V1-V6) may be added to the active vertex queue. The decoder may receive the seed face degree (e.g., FD6) and creates a corresponding face. The decoder may fill all the slots for the incident vertices, moving the incident vertices from the empty to active state, e.g., enters the incident vertices into an active vertex queue of the decoder. Thus, the encoder and the decoder may maintain matching states.

The traversal such as the traversal sequence (800) may continue by removing the highest priority active vertex from the active vertex queue and making it the current vertex. The algorithm proceeds, for example, counterclockwise around the active vertex, skipping all faces which have already been completed. In an example, for an active vertex, at least one face is completed and at least one incident face is still empty, otherwise the vertex may not be in the active vertex queue.

When the encoder detects an empty face, such as an empty slot in the incident face data structure associated with the current vertex, the encoder may proceed through the following steps: (i) the face is activated and becomes the “current” face, and a face degree of the current face is output; (ii) the current face is added to an appropriate slot in the incident face data structures associated with the current vertex as well as any other active vertices which are incident to current face; (iii) any remaining empty vertices of the current face are activated and the respective vertex degrees output in an order, for example, in a counterclockwise order; and (iv) the current face is complete and removed from processing.

In an aspect, referring to FIGS. 8-9, the active vertex and the subsequently selected active face may be considered as successive pivots, and may be referred to as a pivot vertex and a current face, respectively.

The decoder may use a symmetric procedure, ensuring the same traversal as the encoder. When the decoder finds the first empty face slot in the currently active vertex, the decoder may proceed as follows: (i) read in a face degree and create the face, moving the face from state “empty” to “active,” calling the face the “current” face; (ii) add the current face to the appropriate slot in the active vertex and any other active vertices the current face is incident on; (iii) read the vertex degrees of the remaining empty vertices incident on the current face, activating the remaining empty vertices incident on the current face through insertion into the active vertex queue; (iv) move the current face to the complete state.

In an example, vertices completed during the traversal of the current face are removed from the active vertex queue. The vertices completed during the traversal of the current face no further belong to the boundary of the traversed region. After the current face is processed, the algorithm proceeds to the next face in the currently active vertex until the currently active vertex is complete. Subsequently a new active vertex is taken from the queue and the process repeats until the active vertex queue is empty. If there are some connected components remaining, a new seed face is chosen on it and another component traversal starts.

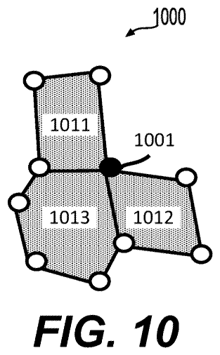

In an aspect, vertices of a polygon mesh may be traversed by an encoder, for example, according to a deterministic order reproducible at a decoder side. In an example, in each step, faces incident to a current vertex may be decomposed into a set of polygon-fans sharing the current vertex as a pivot, such as shown in FIG. 10. FIG. 10 shows an example of a polygon-fan (1000) according to an aspect of the disclosure. The polygon-fan (1000) includes three incident faces (1011)-(1012) that share a pivot (or a pivot vertex) (1001). In an aspect, all faces in a polygon-fan are incident to a pivot vertex, and the polygon-fan includes consecutive faces. Two of the consecutive faces may share an edge.

In an example, connectivity and geometry of polygon-fans are encoded in an interleaved manner. For each polygon-fan, connectivity information of the respective polygon-fan is encoded.

Various vertex traversal methods may be used. The vertex traversal methods may include valence-based traversal, geometry-based traversal, and the like. The valence-based traversal and the geometry-based traversal may keep track of a list of active vertices, which correspond to vertices to be visited and compressed next. The vertices in the list may be stored in a priority queue such as an active vertex priority queue described in the disclosure and visited according to the priority (e.g., vertices with the highest priority are visited first). The valence-based traversal and the geometry-based traversal may define two different priority measures. In an example, the valence-based traversal exploits the connectivity information and measures the priority of an active vertex by counting a number of already encoded polygons (e.g., triangles) incident to the active vertex. The geometry-based traversal may exploit both the connectivity and geometry information. The geometry-based traversal may measure the priority of an active vertex by computing conquered valence, for example, defined as a sum of angles (e.g., diamond angles) of already encoded polygons (e.g., triangles) incident to it.

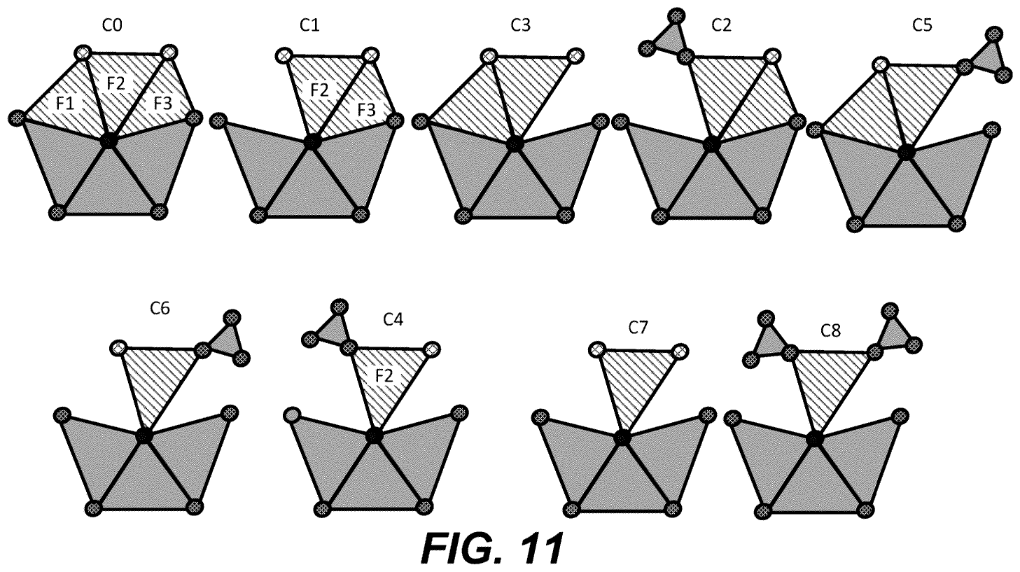

In some examples, a polygon-fan is triangulated and a number of triangles for each face may be compressed by using the context adaptive binary arithmetic. In an example, the connectivity of the obtained triangle-fans is compressed by using nine topological configurations C0-C8 shown in FIG. 11. FIG. 11 shows an example of topological configurations C0-C8 used to compress a triangle-fan connectivity according to an aspect of the disclosure. Referring to FIG. 11, a polygon-fan of each topological configuration includes hatched face(s). For example, the polygon-fan of C0 includes 3 hatched face(s) F1-F3, the polygon-fan of C1 includes 2 hatched face(s) F2-F3, and the polygon-fan of C4 includes 1 hatched face.

In an aspect, the polygon-fan method may be used to code (e.g., encode and/or decode) connectivity of a polygon mesh. To code (e.g., encode and/or decode) the connectivity at a pivot vertex, the polygon-fan method may determine polygon-fans. For each polygon-fan, a number of faces and a face degree of each face may be coded using an entropy coding method. In some examples, a polygon-fan may be triangulated, resulting in a triangle-fan, whose connectivity is coded (e.g., encoded and/or decoded) using a plurality of topological configurations shown in FIG. 11.

The genus of a connected, orientable surface may be an integer representing a maximum number of cuttings along non-intersecting closed simple curves without rendering the resultant manifold disconnected. The genus of a connected, orientable surface may be equal to a number of handles on the connected, orientable surface. In an example, the genus is a number of “holes” that an object has. For example, a sphere has a genus of 0, and a torus has a genus of 1.

In some examples, when a decoder creates a current face, vertices (e.g., all vertices) which may be obtained from neighboring faces are already active. In some examples, the current face is incident to an active vertex, without this fact being deducible, and this situation may be referred to as a split, and the active vertex may be referred to as a split vertex. In some examples, a split vertex is an active index that is an already visited vertex incident to the current face but the incident relationship cannot be deduced from the already visited vertices and/or faces. In some examples, such as in the dual-degree based polygon mesh compression algorithm or a polygon-fan based polygon mesh compression algorithm, splits may occur and split vertices may be encountered.

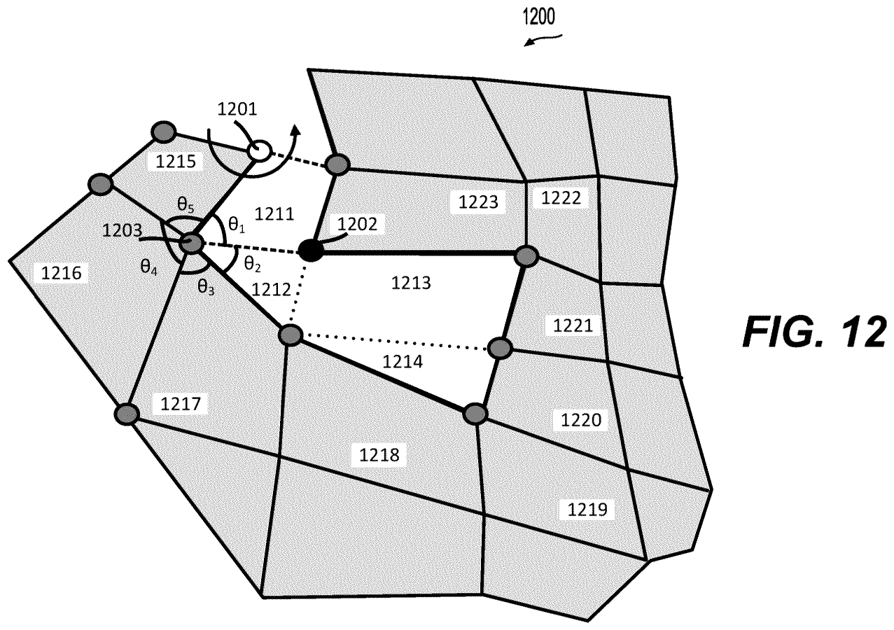

FIG. 12 shows an example of a split vertex (1202) according to an aspect of the disclosure. A polygon mesh (1200) is being coded, such as being encoded or decoded. The polygon mesh (1200) includes a plurality of faces. The plurality of faces includes a first set of faces that are visited or processed (marked by gray color) and a second set of faces that are not visited or not processed (marked by white color). In an aspect, for a face that is visited or processed, face degree information indicating a face degree of the face is already coded (e.g., encoded or decoded) and vertex degree information indicating a vertex degree of each vertex incident to the face is already coded (e.g., encoded or decoded). In an aspect, for the face that is processed, face information indicating the face is added to a respective face data structure associated with each vertex incident to the face. A face that is processed may also be referred to as a complete face and a state of the face that is processed is complete. For example, the first set of faces that are processed includes faces (1215)-(1223). The second set of faces that are not visited includes faces (1211)-(1214).

Referring to FIG. 12, a vertex (1201) is a pivot vertex incident to a current face (1211). The current face (1211) is being processed. The vertex (1202) incident to the current face (1211) is a split vertex since the split vertex (1202) cannot be linked to the current face (1211) based on a relationship between the current face (1211) and the already visited faces and/or vertices.

In an aspect, splits may occur when encoding non-zero genus models, such as a polygon mesh having a genus that is larger than 0. In some examples, split vertices are inevitable, for example, when using a dual-degree algorithm to code polygon meshes of non-zero genus because the traversal in the dual-degree algorithm without splits creates regions homeomorphic to disks. In some examples, splits may occur for models of genus zero, for example, a split may occur when coding polygon meshes of zero genus.

When the encoder detects a split situation, e.g., the encoder is about to activate a vertex which is already active, the encoder may indicate that the vertex is a split vertex. In some examples, a split index is an active index in a plurality of active vertices. In an example, the plurality of active vertices are included in an active vertex queue (e.g., an active vertex priority queue), and the split index may be indicated by signaling an offset of the split vertex (also referred to as a split vertex offset or a split offset), such as information that indicates which active vertex in the active vertex priority queue is the split vertex. In an example, the split vertex offset is indicated using a split vertex index (also referred to as a split index) indicating which active vertex in the active vertex priority queue is the split vertex.

Data structure associated with the split vertex (1202) may indicate faces incident to the split vertex (1202). The data structure associated with the split vertex (1202) may indicate a vertex degree of the split vertex (1202), such as 4 as shown in FIG. 12, and references to incident faces (e.g., the faces (1223) and (1211)-(1213)) of the split vertex (1202), for example, in an order such as a counterclockwise order. The data structure associated with the split vertex (1202) may indicate that the face (1223) is incident to the split vertex (1202). In an example, when the active vertex (1202) incident to the current face (1211) is determined to be the split vertex, a position of the current face (1211) in the data structure associated with the split vertex (1202) may be indicated. In some examples, a second syntax element that indicates the position of the current face (1211) in the data structure associated with the split vertex (1202) may be encoded and signaled. In an example, the position of the current face (1211) in the data structure associated with the split vertex (1202) may indicate spatial relationship(s) of the current face (1211) with respect to other face(s) incident to the split vertex (1202).

In an example, the references to the incident faces (1223) and (1211)-(1213) of the split vertex (1202) may be in the counterclockwise order. A position (also referred to as a split position) of the face (1223) in the data structure associated with the split vertex (1202) is a first position, and the position of the current face (1211) in the data structure associated with the split vertex (1202) is a second position, for example, indicating that the face (1211) is the next face after the face (1223) in the counterclockwise order. In this case, for the split vertex (1202), the split position of the face (1223) is 1, and the split position of the face (1211) is 2.

The dual-degree method and the polygon-fan method may be used to efficiently compress polygon meshes to encoder the connectivity. In various examples, in the dual-degree method and the polygon-fan method, signaling split vertex offsets and/or split positions of respective split vertices occupies a large portion of connectivity bitstream, and thus a large amount of connectivity bitstream may be consumed by signaling split offsets and positions. In some examples, to reduce a number of splits, a visited region may be maintained as convex as possible, and pivot vertex selection criteria may be designed to maintain the convexity of the visited region.

According to an aspect of the disclosure, methods may be applied to select pivot vertices for polygon mesh compression. The methods for pivot vertices selection may be applied individually or by any form of combinations.

In an aspect, a polygon mesh may include a plurality of vertices and a plurality of faces. When coding (e.g., encoding or decoding) connectivity information of the polygon mesh, the plurality of vertices may include a plurality of active vertices. In some examples, an active index having the highest priority in the plurality of active vertices is traversed prior to other active indices in the plurality of active vertices. Thus, an order that the plurality of active vertices may be traversed may depend on how a priority of an active vertex is determined. Accordingly, certain methods in determining priorities of active vertices may be used to reduce a number of splits or a number of split vertices, and thus improving efficiencies of connectivity coding.

As described above, in an aspect, an active vertex queue includes the plurality of active vertices. In some examples, the active vertex queue is an active vertex priority queue where an active index having the highest priority is traversed prior to other active indices in the active vertex queue. For example, the active vertex having the highest priority is selected as the current vertex to be processed (e.g., the pivot vertex), and is processed and then removed from the active vertex queue.

As described above, various vertex traversal methods may define different priority measures. According to an aspect of the disclosure, an active vertex may be selected from a plurality of active vertices in the plurality of vertices of the polygon mesh as a pivot vertex that is to be processed based on a priority of the active vertex. For example, the active vertex may be selected from the active vertex queue (e.g., the active vertex priority queue) that includes the plurality of active vertices as the pivot vertex based on the priority of the active vertex. The active vertex may be selected from the plurality of active vertices as the pivot vertex based on the priorities of the respective active vertices.

The priority criteria used to determine the priorities of the respective active vertices may maintain the convexity of a visited region as much as possible. The priority of the active vertex may be based on one of (i) a number of processed faces to which the active vertex is incident, (ii) a sum of an angle (also referred to as a corner angle) of each processed incident corner of the active vertex, (iii) a number of unprocessed faces to which the active vertex is incident, and (iv) a number of unprocessed face fans to which the active vertex is incident. In an aspect, the priority of the active vertex may be determined based on (i) the number of processed faces to which the active vertex is incident, (ii) the sum of the angle of each processed incident corner of the active vertex, (iii) the number of unprocessed faces to which the active vertex is incident, and (iv) the number of unprocessed face fans to which the active vertex is incident.

The active vertex may be incident to at least one processed face and at least one unprocessed face. Each face fan may include one face to which the active vertex is incident or consecutive faces to which the active vertex is incident. In an aspect, the connectivity information of the polygon mesh may be coded (e.g., reconstructed or encoded) using the selected active vertex as the pivot vertex.

Referring to FIG. 12, in an example, the plurality of active vertices of the polygon mesh (1200) includes a vertex (1203) and other vertices. The active vertex (1203) is incident to the faces (1211), (1212), (1217), (1216), and (1215). The faces (1211) and (1212) are unprocessed. The faces (1217), (1216), and (1215) are processed or are already processed. Thus, for the active vertex (1203), a number of processed faces to which the active vertex (1203) is incident is 3, and a number of unprocessed faces to which the active vertex (1203) is incident is 2. A first face fan includes the faces (1211) and (1212) and is unprocessed. A second face fan includes the faces (1217), (1216), and (1215) and is processed. A number of unprocessed face fans to which the active vertex (1203) is incident is 1. The incident corners of active vertex (1203) correspond to the faces (1211), (1212), (1217), (1216), and (1215), respectively. The incident corners corresponding to the faces (1211) and (1212), respectively, are unprocessed and have angles θ₁ and θ₂, respectively. The incident corners corresponding to the faces (1217), (1216), and (1215), respectively, are processed, and have angles θ₃, θ₄, and θ₅, respectively. A sum of an angle of each processed incident corner of the active vertex (1203) is (θ₃+θ₄+θ₅). The active vertex (1203) is incident to at least one processed face including (1215)-(1217) and at least one unprocessed face including (1211) and (1212).

In an aspect, the priority of the active vertex may be based on the number of the processed faces to which the active vertex is incident. In an example, the priority of the active vertex increases with the number of the processed faces to which the active vertex is incident. For example, for an active vertex (e.g., (1203)) which is a visited vertex but not all of incident faces of the visited vertex have been processed, a number of processed incident faces (e.g., already processed incident faces (1217), (1216), and (1215)) may be used as a priority of the active index to be selected as a pivot vertex such as a next pivot vertex. This criteria in determining the priority of the active index based on the number of the processed faces to which the active vertex is incident may be applicable to various polygon mesh compression methods such as the dual-degree based method, the polygon-fan based method, and the like.

In an aspect, the priority of the active vertex is based on the sum of the angle of each respective processed incident corner of the active vertex. In an example, the priority of the active vertex increases with an increase of the sum. For example, for an active vertex (e.g., (1203)), the sum of the angles of all the processed incident corners of the vertex may be computed, then the sum may be used as the priority of the vertex. Diamond angles may be used to approximate the corner angles (e.g., θ₁ to θ₅), for example, to make the computation of the angles faster. In an example, a corner angle of an active vertex is efficiently approximated by dividing a constant number with the degree of the active vertex (e.g., a vertex degree which is a number of its incident faces) if the vertex degree is known. Using a diamond angle is an example of an approximate way to represent a corner angle. For example, when diamond angles are used, one of 64 different numbers may be used to represent an angle between 0 to 360°, and one of 32 different numbers may be used to represent an angle between 0 to 180°. Any method to represent a corner angle may be used in calculating the corner angle.

In an aspect, the priority of the active vertex is based on a constant (or a constant number) subtracted from the sum of the angle of each respective processed incident corner of the active vertex. For example, the angle-based priority described above may be modified by subtracting the constant number. Specifically, for an active vertex, every time one of its incident corners is visited and the respective angle is computed, the angle may be added to the priority (e.g., the sum) and then the constant number may be subtracted from the priority. For example, the priority of the active vertex (1203) may be equal to (θ₃+θ₄+θ₅−C) where C is the constant number.

The angle-based priority may be applicable to various polygon mesh compression methods such as the dual-degree based method, the polygon-fan based method, and the like.

In an aspect, the priority of the active vertex is based on the number of the unprocessed faces to which the active vertex is incident. For example, the priority of the active vertex may decrease with the number of the unprocessed faces to which the active vertex is incident. In an example, for an active vertex, if the number N1 of incident faces that have not been processed is known, a negative of the number (e.g., −N1) of the incident faces that have not been processed may be used or the number may be subtracted from a constant as the priority of the active vertex. The priority based on the number of the unprocessed faces may be applicable to various polygon mesh compression methods such as the dual-degree based method.

In an aspect, the priority of the active vertex is based on the number of the unprocessed face fans to which the active vertex is incident. For example, the priority of the active vertex may decrease with the number of the unprocessed face fans to which the active vertex is incident. In an example, for an active vertex, if the number of incident face fans that have not been processed is known, a negative of the number of the incident face fans that have not been processed may be used or the number may be subtracted from a constant as the priority of the active vertex. The priority based on the number of the unprocessed face fans may be applicable to various polygon mesh compression methods such as the dual-degree based method.

In an example, the priority of the active vertex is based on a number of processed face fans to which the active vertex is incident. For example, the priority of the active vertex may increase with the number of the processed face fans to which the active vertex is incident.

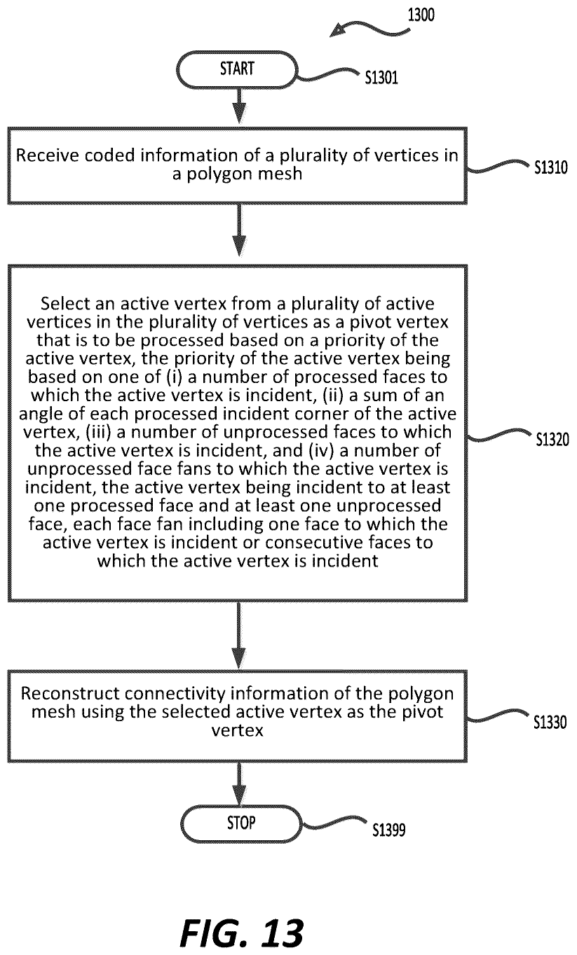

FIG. 13 shows a flow chart outlining a process (1300) according to an aspect of the disclosure. The process (1300) can be used in an apparatus. The apparatus may include a mesh decoder, such as a video decoder. The video decoder is configured to, for example, decode connectivity information of a mesh such as a polygon mesh. In various aspects, the process (1300) is executed by processing circuitry, such as the processing circuitry that performs functions of the video decoder (110), the processing circuitry that performs functions of the video decoder (210), the mesh decoder, and/or the like. In some aspects, the process (1300) is implemented in software instructions, thus when the processing circuitry executes the software instructions, the processing circuitry performs the process (1300). The process starts at (S1301) and proceeds to (S1310).

At (S1310), the process (1300) includes receiving coded information of a plurality of vertices in the polygon mesh.

At (S1320), the process (1300) includes selecting an active vertex from a plurality of active vertices in the plurality of vertices as a pivot vertex that is to be processed based on a priority of the active vertex. The priority of the active vertex is based on one of (i) a number of processed faces to which the active vertex is incident, (ii) a sum of an angle of each processed incident corner of the active vertex, (iii) a number of unprocessed faces to which the active vertex is incident, and (iv) a number of unprocessed face fans to which the active vertex is incident. The active vertex is incident to at least one processed face and at least one unprocessed face. Each face fan includes one face to which the active vertex is incident or consecutive faces to which the active vertex is incident.

At (S1330), the process (1300) includes reconstructing the connectivity information of the polygon mesh using the selected active vertex as the pivot vertex.

Then, the process proceeds to (S1399) and terminates.

The process (1300) can be suitably adapted. Step(s) in the process (1300) can be modified and/or omitted. Additional step(s) can be added. Any suitable order of implementation can be used.

In an aspect, the reconstructing the connectivity information of the polygon mesh includes reconstructing the connectivity information of the polygon mesh using a dual-degree based polygon mesh compression method that uses a sequence of vertex degrees and a sequence of face degrees. In an example, the priority of the active vertex is based on the number of the processed faces to which the active vertex is incident. In an example, the priority of the active vertex is based on the sum of the angle of each respective processed incident corner of the active vertex. In an example, the priority of the active vertex is based on a constant subtracted from the sum of the angle of each respective processed incident corner of the active vertex. In an example, the priority of the active vertex is based on the number of the unprocessed faces to which the active vertex is incident. In an example, the priority of the active vertex is based on the number of the unprocessed face fans to which the active vertex is incident.

In an aspect, the reconstructing the connectivity information of the polygon mesh includes reconstructing the connectivity information of the polygon mesh using a polygon-fan based polygon mesh compression method that uses a sequence of face degrees. In an example, the priority of the active vertex is based on the number of the processed faces to which the active vertex is incident. In an example, the priority of the active vertex is based on the sum of the angle of each respective processed incident corner of the active vertex. In an example, the priority of the active vertex is based on a constant subtracted from the sum of the angle of each respective processed incident corner of the active vertex.

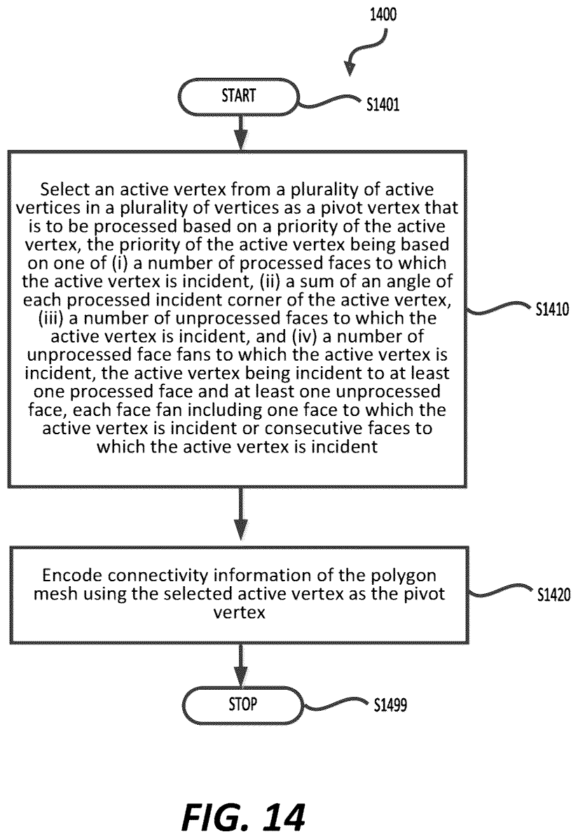

FIG. 14 shows a flow chart outlining a process (1400) according to an aspect of the disclosure. The process (1400) can be used in an apparatus. The apparatus may include a mesh encoder, such as a video encoder. The video encoder is configured to, for example, to encode connectivity information of a mesh such as a polygon mesh. In various aspects, the process (1400) is executed by processing circuitry, such as the processing circuitry that performs functions of the video encoder (103), the processing circuitry that performs functions of the video encoder (303), the mesh encoder, and/or the like. In some aspects, the process (1400) is implemented in software instructions, thus when the processing circuitry executes the software instructions, the processing circuitry performs the process (1400). The process starts at (S1401) and proceeds to (S1410).

At (S1410), the process (1400) includes selecting an active vertex from a plurality of active vertices in a plurality of vertices as a pivot vertex that is to be processed based on a priority of the active vertex. The plurality of vertices is in the polygon mesh. The priority of the active vertex is based on one of (i) a number of processed faces to which the active vertex is incident, (ii) a sum of an angle of each processed incident corner of the active vertex, (iii) a number of unprocessed faces to which the active vertex is incident, and (iv) a number of unprocessed face fans to which the active vertex is incident. The active vertex is incident to at least one processed face and at least one unprocessed face. Each face fan includes one face to which the active vertex is incident or consecutive faces to which the active vertex is incident.

At (S1410), the process (1400) includes encoding the connectivity information of the polygon mesh using the selected active vertex as the pivot vertex.

Then, the process proceeds to (S1499) and terminates.

The process (1400) can be suitably adapted. Step(s) in the process (1400) can be modified and/or omitted. Additional step(s) can be added. Any suitable order of implementation can be used.

In an aspect, the encoding the connectivity information of the polygon mesh includes encoding the connectivity information of the polygon mesh using a dual-degree based polygon mesh compression method that uses a sequence of vertex degrees and a sequence of face degrees. In an example, the priority of the active vertex is based on the number of the processed faces to which the active vertex is incident. In an example, the priority of the active vertex is based on the sum of the angle of each respective processed incident corner of the active vertex. In an example, the priority of the active vertex is based on the number of the unprocessed faces to which the active vertex is incident. In an example, the priority of the active vertex is based on the number of the unprocessed face fans to which the active vertex is incident.

In an aspect, the encoding the connectivity information of the polygon mesh includes encoding the connectivity information of the polygon mesh using a polygon-fan based polygon mesh compression method that uses a sequence of face degrees. In an example, the priority of the active vertex is based on the number of the processed faces to which the active vertex is incident or the sum of the angle of each respective processed incident corner of the active vertex.

In an aspect, a method of processing connectivity information of a polygon mesh includes processing a connectivity bitstream of the connectivity information of the polygon mesh according to a format rule. For example, the bitstream is a bitstream that is decoded/encoded in any of the decoding and/or encoding methods described herein. The format rule may specify one or more constraints of the bitstream and/or one or more processes to be performed by the decoder and/or encoder.

In an aspect, the method of processing mesh data includes processing connectivity information of a polygon mesh and the bitstream includes a connectivity bitstream including connectivity information of a polygon mesh. The connectivity bitstream may include syntax elements indicating a plurality of vertices in the polygon mesh. The format rule specifies that an active vertex is selected from a plurality of active vertices in the plurality of vertices as a pivot vertex that is to be processed based on a priority of the active vertex. The priority of the active vertex is based on one of (i) a number of processed faces to which the active vertex is incident, (ii) a sum of an angle of each processed incident corner of the active vertex, (iii) a number of unprocessed faces to which the active vertex is incident, and (iv) a number of unprocessed face fans to which the active vertex is incident. The active vertex is incident to at least one processed face and at least one unprocessed face. Each face fan includes one face to which the active vertex is incident or consecutive faces to which the active vertex is incident. The format rule specifies that the connectivity information of the polygon mesh is reconstructed using the selected active vertex as the pivot vertex.

The methods, aspects, and examples in the disclosure may be used separately or combined in any order. For example, some aspects and/or examples performed by the decoder may be performed by the encoder and vice versa. Each of the methods (or aspects), an encoder, and a decoder may be implemented by processing circuitry (e.g., one or more processors or one or more integrated circuits). In one example, the one or more processors execute a program that is stored in a non-transitory computer-readable medium.

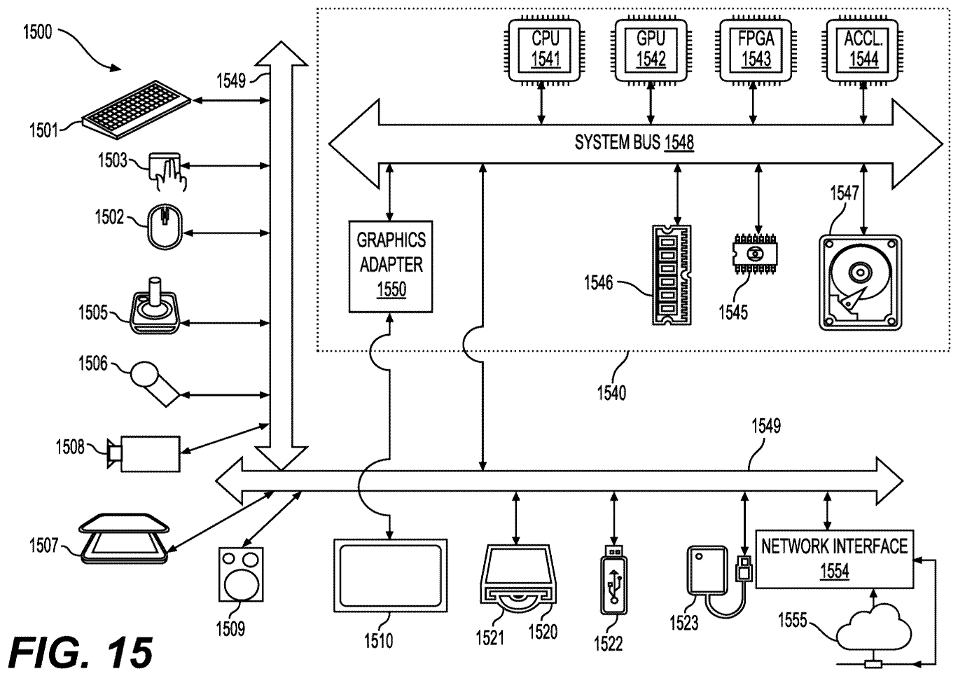

The techniques described above, can be implemented as computer software using computer-readable instructions and physically stored in one or more computer-readable media. For example, FIG. 15 shows a computer system (1500) suitable for implementing certain aspects of the disclosed subject matter.

The computer software can be coded using any suitable machine code or computer language, that may be subject to assembly, compilation, linking, or like mechanisms to create code comprising instructions that can be executed directly, or through interpretation, micro-code execution, and the like, by one or more computer central processing units (CPUs), Graphics Processing Units (GPUs), and the like.

The instructions can be executed on various types of computers or components thereof, including, for example, personal computers, tablet computers, servers, smartphones, gaming devices, internet of things devices, and the like.

The components shown in FIG. 15 for computer system (1500) are examples and are not intended to suggest any limitation as to the scope of use or functionality of the computer software implementing aspects of the present disclosure. Neither should the configuration of components be interpreted as having any dependency or requirement relating to any one or combination of components illustrated in the example aspect of a computer system (1500).

Computer system (1500) may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices can also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard (1501), mouse (1502), trackpad (1503), touch screen (1510), data-glove (not shown), joystick (1505), microphone (1506), scanner (1507), camera (1508).

Computer system (1500) may also include certain human interface output devices. Such human interface output devices may be stimulating the senses of one or more human users through, for example, tactile output, sound, light, and smell/taste. Such human interface output devices may include tactile output devices (for example tactile feedback by the touch-screen (1510), data-glove (not shown), or joystick (1505), but there can also be tactile feedback devices that do not serve as input devices), audio output devices (such as: speakers (1509), headphones (not depicted)), visual output devices (such as screens (1510) to include CRT screens, LCD screens, plasma screens, OLED screens, each with or without touch-screen input capability, each with or without tactile feedback capability-some of which may be capable to output two dimensional visual output or more than three dimensional output through means such as stereographic output; virtual-reality glasses (not depicted), holographic displays and smoke tanks (not depicted)), and printers (not depicted).

Computer system (1500) can also include human accessible storage devices and their associated media such as optical media including CD/DVD ROM/RW (1520) with CD/DVD or the like media (1521), thumb-drive (1522), removable hard drive or solid state drive (1523), legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system (1500) can also include an interface (1554) to one or more communication networks (1555). Networks can for example be wireless, wireline, optical. Networks can further be local, wide-area, metropolitan, vehicular and industrial, real-time, delay-tolerant, and so on. Examples of networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks commonly require external network interface adapters that attached to certain general purpose data ports or peripheral buses (1549) (such as, for example USB ports of the computer system (1500)); others are commonly integrated into the core of the computer system (1500) by attachment to a system bus as described below (for example Ethernet interface into a PC computer system or cellular network interface into a smartphone computer system). Using any of these networks, computer system (1500) can communicate with other entities. Such communication can be uni-directional, receive only (for example, broadcast TV), uni-directional send-only (for example CANbus to certain CANbus devices), or bi-directional, for example to other computer systems using local or wide area digital networks. Certain protocols and protocol stacks can be used on each of those networks and network interfaces as described above.

Aforementioned human interface devices, human-accessible storage devices, and network interfaces can be attached to a core (1540) of the computer system (1500).

The core (1540) can include one or more Central Processing Units (CPU) (1541), Graphics Processing Units (GPU) (1542), specialized programmable processing units in the form of Field Programmable Gate Areas (FPGA) (1543), hardware accelerators for certain tasks (1544), graphics adapters (1550), and so forth. These devices, along with Read-only memory (ROM) (1545), Random-access memory (1546), internal mass storage such as internal non-user accessible hard drives, SSDs, and the like (1547), may be connected through a system bus (1548). In some computer systems, the system bus (1548) can be accessible in the form of one or more physical plugs to enable extensions by additional CPUs, GPU, and the like. The peripheral devices can be attached either directly to the core's system bus (1548), or through a peripheral bus (1549). In an example, the screen (1510) can be connected to the graphics adapter (1550). Architectures for a peripheral bus include PCI, USB, and the like.

CPUs (1541), GPUs (1542), FPGAs (1543), and accelerators (1544) can execute certain instructions that, in combination, can make up the aforementioned computer code. That computer code can be stored in ROM (1545) or RAM (1546). Transitional data can also be stored in RAM (1546), whereas permanent data can be stored for example, in the internal mass storage (1547). Fast storage and retrieve to any of the memory devices can be enabled through the use of cache memory, that can be closely associated with one or more CPU (1541), GPU (1542), mass storage (1547), ROM (1545), RAM (1546), and the like.

The computer readable media can have computer code thereon for performing various computer-implemented operations. The media and computer code can be those specially designed and constructed for the purposes of the present disclosure, or they can be of the kind well known and available to those having skill in the computer software arts.

As an example and not by way of limitation, the computer system having architecture (1500), and specifically the core (1540) can provide functionality as a result of processor(s) (including CPUs, GPUs, FPGA, accelerators, and the like) executing software embodied in one or more tangible, computer-readable media. Such computer-readable media can be media associated with user-accessible mass storage as introduced above, as well as certain storage of the core (1540) that are of non-transitory nature, such as core-internal mass storage (1547) or ROM (1545). The software implementing various aspects of the present disclosure can be stored in such devices and executed by core (1540). A computer-readable medium can include one or more memory devices or chips, according to particular needs. The software can cause the core (1540) and specifically the processors therein (including CPU, GPU, FPGA, and the like) to execute particular processes or particular parts of particular processes described herein, including defining data structures stored in RAM (1546) and modifying such data structures according to the processes defined by the software. In addition or as an alternative, the computer system can provide functionality as a result of logic hardwired or otherwise embodied in a circuit (for example: accelerator (1544)), which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

The use of “at least one of” or “one of” in the disclosure is intended to include any one or a combination of the recited elements. For example, references to at least one of A, B, or C; at least one of A, B, and C; at least one of A, B, and/or C; and at least one of A to Care intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

While this disclosure has described several examples of aspects, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

The above disclosure also encompasses the features noted below. The features may be combined in various manners and are not limited to the combinations noted below.

(1) A method for decoding connectivity information of a polygon mesh, the method including: receiving coded information of a plurality of vertices in the polygon mesh; selecting an active vertex from a plurality of active vertices in the plurality of vertices as a pivot vertex that is to be processed based on a priority of the active vertex from the plurality of active vertices, the priority of the active vertex being based on one of (i) a number of processed faces to which the active vertex is incident, (ii) a sum of an angle of each processed incident corner of the active vertex, (iii) a number of unprocessed faces to which the active vertex is incident, and (iv) a number of unprocessed face fans to which the active vertex is incident, the active vertex being incident to at least one processed face and at least one unprocessed face, each face fan including one face to which the active vertex is incident or consecutive faces to which the active vertex is incident; and reconstructing the connectivity information of the polygon mesh using the selected active vertex as the pivot vertex.

(2) The method of feature (1), in which the reconstructing the connectivity information of the polygon mesh includes: reconstructing the connectivity information of the polygon mesh using a dual-degree based polygon mesh compression method that uses a sequence of vertex degrees and a sequence of face degrees.

(3) The method of feature (1) or feature (2), in which the priority of the active vertex is based on the number of the processed faces to which the active vertex is incident.

(4) The method of feature (1) or feature (2), in which the priority of the active vertex is based on the sum of the angle of each respective processed incident corner of the active vertex.

(5) The method of feature (4), in which the priority of the active vertex is based on a constant subtracted from the sum of the angle of each respective processed incident corner of the active vertex.

(6) The method of feature (1) or feature (2), in which the priority of the active vertex is based on the number of the unprocessed faces to which the active vertex is incident.

(7) The method of feature (1) or feature (2), in which the priority of the active vertex is based on the number of the unprocessed face fans to which the active vertex is incident.

(8) The method of feature (1), in which the reconstructing the connectivity information of the polygon mesh includes: reconstructing the connectivity information of the polygon mesh using a polygon-fan based polygon mesh compression method that uses a sequence of face degrees.

(9) The method of feature (8), in which the priority of the active vertex is based on the number of the processed faces to which the active vertex is incident.

(10) The method of feature (8), in which the priority of the active vertex is based on the sum of the angle of each respective processed incident corner of the active vertex.

(11) The method of feature (10), in which the priority of the active vertex is based on a constant subtracted from the sum of the angle of each respective processed incident corner of the active vertex.

(12) A method for encoding connectivity information of a polygon mesh, the method including: selecting an active vertex from a plurality of active vertices in a plurality of vertices as a pivot vertex that is to be processed based on a priority of the active vertex from the plurality of active vertices, the plurality of vertices being in the polygon mesh, the priority of the active vertex being based on one of (i) a number of processed faces to which the active vertex is incident, (ii) a sum of an angle of each processed incident corner of the active vertex, (iii) a number of unprocessed faces to which the active vertex is incident, and (iv) a number of unprocessed face fans to which the active vertex is incident, the active vertex being incident to at least one processed face and at least one unprocessed face, each face fan including one face to which the active vertex is incident or consecutive faces to which the active vertex is incident; and encoding the connectivity information of the polygon mesh using the selected active vertex as the pivot vertex.

(13) The method of feature (12), in which the encoding the connectivity information of the polygon mesh comprises encoding the connectivity information of the polygon mesh using a dual-degree based polygon mesh compression method that uses a sequence of vertex degrees and a sequence of face degrees.

(14) The method of feature (12) or feature (13), in which the priority of the active vertex is based on the number of the processed faces to which the active vertex is incident.

(15) The method of feature (12) or feature (13), in which the priority of the active vertex is based on the sum of the angle of each respective processed incident corner of the active vertex.

(16) The method of feature (12) or feature (13), in which the priority of the active vertex is based on the number of the unprocessed faces to which the active vertex is incident.

(17) The method of feature (12) or feature (13), in which the priority of the active vertex is based on the number of the unprocessed face fans to which the active vertex is incident.

(18) The method of feature (12), in which the encoding the connectivity information of the polygon mesh comprises encoding the connectivity information of the polygon mesh using a polygon-fan based polygon mesh compression method that uses a sequence of face degrees.

(19) The method of feature (18), in which the priority of the active vertex is based on the number of the processed faces to which the active vertex is incident or the sum of the angle of each respective processed incident corner of the active vertex.

(20) A method of processing connectivity information of a polygon mesh, the method including: processing a connectivity bitstream of the connectivity information of the polygon mesh according to a format rule, in which the connectivity bitstream includes syntax elements indicating a plurality of vertices in the polygon mesh; and the format rule specifies that an active vertex is selected from a plurality of active vertices in the plurality of vertices as a pivot vertex that is to be processed based on a priority of the active vertex from the plurality of active vertices, the priority of the active vertex being based on one of (i) a number of processed faces to which the active vertex is incident, (ii) a sum of an angle of each processed incident corner of the active vertex, (iii) a number of unprocessed faces to which the active vertex is incident, and (iv) a number of unprocessed face fans to which the active vertex is incident, the active vertex being incident to at least one processed face and at least one unprocessed face, each face fan including one face to which the active vertex is incident or consecutive faces to which the active vertex is incident; and the connectivity information of the polygon mesh is reconstructed using the selected active vertex as the pivot vertex.

(21) An apparatus for video decoding, including processing circuitry that is configured to perform the method of any of features (1) to (11).

(22) An apparatus for video encoding, including processing circuitry that is configured to perform the method of any of features (12) to (19).

(23) A non-transitory computer-readable storage medium storing instructions which when executed by at least one processor cause the at least one processor to perform the method of any of features (1) to (19).

What is claimed is:

1. A method for decoding connectivity information of a polygon mesh, the method comprising:
receiving coded information of a plurality of vertices in the polygon mesh;
selecting an active vertex from a plurality of active vertices in the plurality of vertices as a pivot vertex that is to be processed based on a priority of the active vertex, the priority of the active vertex being based on one of (i) a number of processed faces to which the active vertex is incident, (ii) a sum of an angle of each processed incident corner of the active vertex, (iii) a number of unprocessed faces to which the active vertex is incident, and (iv) a number of unprocessed face fans to which the active vertex is incident, the active vertex being incident to at least one processed face and at least one unprocessed face, each face fan including one face to which the active vertex is incident or consecutive faces to which the active vertex is incident; and
reconstructing the connectivity information of the polygon mesh using the selected active vertex as the pivot vertex.

2. The method of claim 1, wherein the reconstructing the connectivity information of the polygon mesh comprises:
reconstructing the connectivity information of the polygon mesh using a dual-degree based polygon mesh compression method that uses a sequence of vertex degrees and a sequence of face degrees.

3. The method of claim 2, wherein the priority of the active vertex is based on the number of the processed faces to which the active vertex is incident.

4. The method of claim 2, wherein the priority of the active vertex is based on the sum of the angle of each respective processed incident corner of the active vertex.

5. The method of claim 4, wherein the priority of the active vertex is based on a constant subtracted from the sum of the angle of each respective processed incident corner of the active vertex.

6. The method of claim 2, wherein the priority of the active vertex is based on the number of the unprocessed faces to which the active vertex is incident.

7. The method of claim 2, wherein the priority of the active vertex is based on the number of the unprocessed face fans to which the active vertex is incident.

8. The method of claim 1, wherein the reconstructing the connectivity information of the polygon mesh comprises:
reconstructing the connectivity information of the polygon mesh using a polygon-fan based polygon mesh compression method that uses a sequence of face degrees.

9. The method of claim 8, wherein the priority of the active vertex is based on the number of the processed faces to which the active vertex is incident.

10. The method of claim 8, wherein the priority of the active vertex is based on the sum of the angle of each respective processed incident corner of the active vertex.

11. The method of claim 10, wherein the priority of the active vertex is based on a constant subtracted from the sum of the angle of each respective processed incident corner of the active vertex.

12. A method for encoding connectivity information of a polygon mesh, the method comprising:
selecting an active vertex from a plurality of active vertices in a plurality of vertices as a pivot vertex that is to be processed based on a priority of the active vertex, the plurality of vertices being in the polygon mesh, the priority of the active vertex being based on one of (i) a number of processed faces to which the active vertex is incident, (ii) a sum of an angle of each processed incident corner of the active vertex, (iii) a number of unprocessed faces to which the active vertex is incident, and (iv) a number of unprocessed face fans to which the active vertex is incident, the active vertex being incident to at least one processed face and at least one unprocessed face, each face fan including one face to which the active vertex is incident or consecutive faces to which the active vertex is incident; and
encoding the connectivity information of the polygon mesh using the selected active vertex as the pivot vertex.

13. The method of claim 12, wherein the encoding the connectivity information of the polygon mesh comprises:
encoding the connectivity information of the polygon mesh using a dual-degree based polygon mesh compression method that uses a sequence of vertex degrees and a sequence of face degrees.

14. The method of claim 13, wherein the priority of the active vertex is based on the number of the processed faces to which the active vertex is incident.

15. The method of claim 13, wherein the priority of the active vertex is based on the sum of the angle of each respective processed incident corner of the active vertex.

16. The method of claim 13, wherein the priority of the active vertex is based on the number of the unprocessed faces to which the active vertex is incident.

17. The method of claim 13, wherein the priority of the active vertex is based on the number of the unprocessed face fans to which the active vertex is incident.

18. The method of claim 12, wherein the encoding the connectivity information of the polygon mesh comprises:
encoding the connectivity information of the polygon mesh using a polygon-fan based polygon mesh compression method that uses a sequence of face degrees.

19. The method of claim 18, wherein the priority of the active vertex is based on the number of the processed faces to which the active vertex is incident or the sum of the angle of each respective processed incident corner of the active vertex.

20. A method of processing connectivity information of a polygon mesh, the method comprising:
processing a connectivity bitstream of the connectivity information of the polygon mesh according to a format rule, wherein
the connectivity bitstream includes syntax elements indicating a plurality of vertices in the polygon mesh; and
the format rule specifies that
an active vertex is selected from a plurality of active vertices in the plurality of vertices as a pivot vertex that is to be processed based on a priority of the active vertex, the priority of the active vertex being based on one of (i) a number of processed faces to which the active vertex is incident, (ii) a sum of an angle of each processed incident corner of the active vertex, (iii) a number of unprocessed faces to which the active vertex is incident, and (iv) a number of unprocessed face fans to which the active vertex is incident, the active vertex being incident to at least one processed face and at least one unprocessed face, each face fan including one face to which the active vertex is incident or consecutive faces to which the active vertex is incident; and
the connectivity information of the polygon mesh is reconstructed using the selected active vertex as the pivot vertex.
